(19) United States
(12) Patent Application Publication
(10) Pub. No.: US 2006/0012098 A1
(43) Pub. Date: Jan. 19, 2006

(54) Sheet folding and binding apparatus

(76) Inventor: Tamaki Kaneko, Fujisawa-shi (JP)

Correspondence Address: RICHARD F. JAWORSKI;Cooper & Dunham LLP, 1185 Avenue of the Americas, New York, NY, 10036, US

(21) Appl. No.: 11/113,439

(22) Filed: Apr. 22, 2005

(30) Foreign Application Priority Data
Jul. 16, 2004 (JP) 2004-209394

(51) Int. Cl. B41L 43/12

(52) U.S. Cl. 270/37

(57) ABSTRACT

A sheet folding and binding apparatus includes a folding device configured to fold a sheet according to an instruction from an image forming apparatus either at a single folding portion or at two folding portions thereof. The folding device includes a first folding part configured to fold the sheet conveyed by the receiving device, when folding the sheet at a single folding portion thereof, at the single folding portion thereof, and when folding the sheet at two folding portions thereof, at a first folding portion of the two folding portions thereof, and to convey the sheet folded at the single folding portion thereof with the folded single folding portion thereof placed as a leading edge of the sheet and the sheet folded at the first folding portion of the two folding portions thereof with the folded first folding portion thereof placed as a leading edge of the sheet, and a second folding part configured to convey the sheet folded at the single folding portion thereof further, without folding the sheet, and to fold the sheet folded at the first folding portion of the two folding portions thereof at a second folding portion of the two folding portions thereof.

### CROSS-REFERECE TO RELATED APPLICATIONS

The present application claims priority and contains subject matter related to Japanese Patent Application No. 2004-209394 filed in the Japanese Patent Office on Jul. 16, 2004 and the entire contents of which are hereby incorporated herein by reference.

### BACKGROUND OF THE INVENTION

1. Field of the Invention

The present invention relates generally to a sheet folding and binding apparatus used in conjunction with an image forming apparatus such as a copying machine, a printer, etc.

2. Discussion of the Background

Binding apparatuses used in conjunction with an image forming apparatus generally receive sheets discharged from the image forming apparatus one after another, stack and jog the sheets, and then staple the stacked sheets at their one side edge portions.

A known binding system used in producing weekly magazines stacks and jogs printed sheets, and staples the sheets at their center portions by a staple device. The sheets are folded at their stapled center portions, and side edges of the folded sheets opposite the stapled and folded center portions thereof are cut off by a cutting device so as to be uniform.

In a known sheet folding and binding apparatus used in conjunction with an image forming apparatus, a sheet received from the image forming apparatus is folded at a center portion thereof or at two folding portions thereof to be like a letter Z in a cross section (so-called Z-folding) and is then bound. In the sheet folding and binding apparatus, the received sheet is conveyed to a folding part located at a lower part of the apparatus to be folded and is then conveyed to a binding part located at an upper part of the apparatus to be bound through a conveying path between the folding part and the binding part. The conveying path is relatively long, so that the apparatus is relatively large and expensive.

### SUMMARY OF THE INVENTION

The present invention has been made in views of the above-discussed and other problems and addresses the above-discussed and other problems.

Preferred embodiments of the present invention provide a novel sheet folding and binding apparatus capable of folding a received sheet at a single folding portion or at two folding portions thereof, that is relatively compact and inexpensive.

According to an embodiment of the present invention, a sheet folding and binding apparatus connected with an image forming apparatus and operated based on an instruction from the image forming apparatus includes a receiving device configured to receive a sheet discharged from the image forming apparatus and to convey the sheet further, and a folding device configured to fold the sheet conveyed by the receiving device according to the instruction from the image forming apparatus either at a single folding portion or at two folding portions of the sheet and to convey the sheet. The folding device includes a first folding part configured to fold the sheet conveyed by the receiving device, when folding the sheet at a single folding portion thereof, at the single folding portion thereof, and when folding the sheet at two folding portions thereof, at a first folding portion of the two folding portions thereof, and to convey the sheet folded at the single folding portion thereof with the folded single folding portion thereof placed as a leading edge of the sheet and the sheet folded at the first folding portion of the two folding portions thereof with the folded first folding portion thereof placed as a leading edge of the sheet, and a second folding part configured to convey the sheet folded at the single folding portion thereof and conveyed with the folded single folding portion thereof placed as the leading edge of the sheet by the first folding part further, without folding the sheet, and to fold the sheet folded at the first folding portion of the two folding portions thereof and conveyed with the folded first folding portion thereof placed as the leading edge of the sheet by the first folding part, at a second folding portion of the two folding portions thereof and to convey the sheet folded at the first folding portion and the second folding portion thereof with the folded second folding portion thereof placed as a leading edge of the sheet. The apparatus further includes a receiving/jogging device including a tray and configured to receive the sheet conveyed by the folding device one after another on the tray and to jog the sheet one after another so as to be stacked into a stack of the sheet on the tray, a binding device arranged at one end side of the tray of the receiving/jogging device and configured to bind the stack of the sheet on the tray of the receiving/jogging device, and a discharge device configured to discharge the stack of the sheet on the tray of the receiving/jogging device, which has been bound by the binding device. The sheet folded at the single folding portion thereof is bound by the binding device at an edge portion thereof at the folded single folding portion side, and the sheet folded at the first folding portion and the second folding portion thereof is bound by the binding device at an edge portion thereof opposite the folded second folding portion thereof.

In the sheet folding and binding apparatus, the second folding part of the folding device may be configured to discharge the sheet folded at the single folding portion thereof and conveyed with the folded single folding portion thereof placed as the leading edge of the sheet by the first folding part, without holding the sheet, directly onto the tray of the receiving/jogging device from an end side of the tray opposite the one end side thereof where the binding device is arranged, so that the sheet folded at the single folding portion thereof is received by the receiving/jogging device on the tray thereof with the folded single folding portion thereof located at the one end side of the tray where the binding device is arranged and thereby the sheet is bound by the binding device at an edge portion thereof at the folded single folding portion side.

The sheet folding and binding apparatus may comprise a reversing device arranged downstream of the second folding part of the folding device in a direction in which the sheet folded at the first folding portion and the second folding portion thereof is conveyed by the second folding part with the folded second folding portion thereof placed as the leading edge of the sheet and configured to reverse the sheet conveyed by the second folding part and to discharge the sheet directly onto the tray of the receiving/jogging device from the end side of the tray opposite the one end side thereof where the binding device is arranged, so that the sheet folded at the first folding portion and the second folding portion thereof is received by the receiving/jogging device on the tray thereof with an end of the sheet opposite the folded second folding portion thereof located at the one end side of the tray where the binding device is arranged and thereby the sheet folded at the first folding portion and the second folding portion thereof is bound by the binding device at the edge portion thereof opposite the folded second folding portion thereof.

The sheet folding and binding apparatus may comprise a discharge path arranged downstream of the second folding part of the folding device in a direction in which the sheet folded at the first folding portion and the second folding portion thereof is conveyed by the second folding part with the folded second folding portion thereof placed as the leading edge of the sheet and configured to discharge the sheet folded at the first folding portion and the second folding portion thereof and conveyed by the second folding part with the folded second folding portion thereof placed as the leading edge of the sheet onto the tray of the receiving/jogging device from the one end side of the tray where the binding device is arranged, so that the sheet folded at the first folding portion and the second folding portion thereof is received by the receiving/jogging device on the tray thereof with an end of the sheet opposite the folded second folding portion thereof located at the one end side of the tray where the binding device is arranged and thereby the sheet folded at the first folding portion and the second folding portion thereof is bound by the binding device at the edge portion thereof opposite the folded second folding portion thereof.

The sheet folding and binding apparatus may comprise a first conveying path configured to convey the sheet conveyed by the receiving device to the folding device, a second conveying path configured to convey the sheet conveyed by the receiving device, without passing the folding device, directly onto the tray of the receiving/jogging device as an unfolded sheet from the one end side of the tray where the binding device is arranged, and a switching device configured to switch a conveying direction of the sheet conveyed by the receiving device according to the instruction from the image forming apparatus, when folding the sheet at a single folding portion or at two folding portions thereof, to the first conveying path, and when conveying the sheet, without folding the sheet, directly onto the tray of the receiving/jogging device as an unfolded sheet, to the second conveying path, so that the sheet as an unfolded sheet and the sheet folded at the single folding portion or at the two folding portions thereof may be mixed in the stack of the sheet on the tray.

The sheet folding and binding apparatus may comprise a sheet conveying direction correction device arranged between the receiving device and the first folding part of the folding device and configured to correct a deviation in a conveying direction of the sheet conveyed by the receiving device so that the sheet is folded by the first folding part of the folding device in such a manner that, when the sheet is folded at the single folding portion thereof, the folded single folding portion thereof, and when the sheet is folded at the first folding portion of the two folding portions thereof, the folded first folding portion thereof is perpendicular to side edges of the sheet.

### BRIEF DESCRIPTION OF THE DRAWINGS

A more complete appreciation of the present invention and many of the attended advantages thereof will be readily obtained as the present invention becomes better understood by reference to the following detailed description when considered in connection with the accompanying drawings, wherein:

FIG. 1 is a diagram schematically illustrating a system in which a sheet folding and binding apparatus according to an embodiment of the present invention is connected with an image forming apparatus;

FIG. 2A is a diagram illustrating an example of folding and binding sheets in the sheet folding and binding apparatus, in which each sheet is folded at a single folding portion thereof, and the folded sheet is stacked one upon another to be bound at an edge portion thereof at the folded portion side;

FIG. 2B is a diagram illustrating another example of folding and binding sheets in the sheet folding and binding apparatus, in which each sheet is folded at two folding portions thereof to be like a letter Z in a cross section, and the folded sheet is stacked one upon another to be bound at an edge portion thereof opposite the folded portion side;

FIG. 2C is a diagram illustrating another example of folding and binding sheets in the sheet folding and binding apparatus, in which each sheet is stacked one upon another, without being folded, to be bound at an edge portion thereof;

FIG. 2D is a diagram illustrating another example of folding and binding sheets in the sheet folding and binding apparatus, in which a sheet folded at two folding portions thereof to be like a letter Z in a cross section is mixed in unfolded sheets to be bound;

FIG. 3 is a diagram schematically illustrating an exemplary construction of the sheet folding and binding apparatus;

FIG. 4 is a diagram illustrating an exemplary mechanism of moving a roller pair of a second guide part of a folding part of the sheet folding and binding apparatus;

FIG. 5A is a portion of a flowchart of an exemplary operation of the sheet folding and binding apparatus of FIG. 3;

FIG. 5B is another portion of the flowchart of the exemplary operation of the sheet folding and binding apparatus of FIG. 3;

FIG. 5C is still another portion of the flowchart of the exemplary operation of the sheet folding and binding apparatus of FIG. 3;

FIG. 5D is still another portion of the flowchart of the exemplary operation of the sheet folding and binding apparatus of FIG. 3;

FIG. 6 is a diagram illustrating an exemplary construction of a sheet folding and binding apparatus according to another embodiment of the present invention;

FIG. 7A is a portion of a flowchart of an exemplary operation of the sheet folding and binding apparatus of FIG. 6;

FIG. 7B is another portion of the flowchart of the exemplary operation of the sheet folding and binding apparatus of FIG. 6;

FIG. 7C is still another portion of the flowchart of the exemplary operation of the sheet folding and binding apparatus of FIG. 6;

FIG. 7D is still another portion of the flowchart of the exemplary operation of the sheet folding and binding apparatus of FIG. 6;

FIG. 7E is another portion of the flowchart of the exemplary operation of the sheet folding and binding apparatus of FIG. 6;

FIG. 7F is still another portion of the flowchart of the exemplary operation of the sheet folding and binding apparatus of FIG. 6; and

FIG. 7G is still another portion of the flowchart of the exemplary operation of the sheet folding and binding apparatus of FIG. 6.

### DETAILED DESCRIPTION OF THE PREFERRED EMBODIMENTS

Referring now to the drawings, wherein like reference numerals designate identical or corresponding parts throughout the several views, preferred embodiments of the present invention are described.

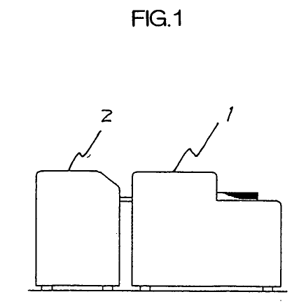

FIG. 1 schematically illustrates a system in which a sheet folding and binding apparatus according to an embodiment of the present invention is connected with an image forming apparatus such as a so-called multi-function digital copier.

An image forming apparatus 1 inputs image data from an original document, a PC, and/or a network, stores the inputted image data, forms images of the inputted image data on print sheets, and discharges the sheets one after another. A sheet binding apparatus 2 as the sheet folding and binding apparatus of the present invention receives the sheets discharged from the image forming apparatus 1 one after another, folds the sheets one after another, and binds the sheets. An instruction of folding and/or binding the sheets is inputted by a user from an operation panel of the image forming apparatus 1 and is transmitted to the sheet binding apparatus 2. The sheet binding apparatus 2 folds and/or binds the sheets discharged from the image forming apparatus 1 according to the instruction received from the image forming apparatus 1.

The instruction includes at least information for each sheet as to whether to fold and bind the sheet or to bind the sheet without folding, whether to fold the sheet at a single folding portion thereof (so-called two-folding) or at two folding portions thereof (so-called Z-folding), the folding portion of the sheet such as, in two-folding, the center portion of the sheet, etc., and in Z-folding, portions corresponding to one-fourth and one-half of the length of the sheet from the leading edge of the sheet, etc., the size of the sheet such as A3, A4, etc., and whether to bind the sheet at an edge portion thereof at the side where the folded portion is located or at the opposite side, and information as to the number of sheets to be bound and the number of sets of a bound stack of sheets.

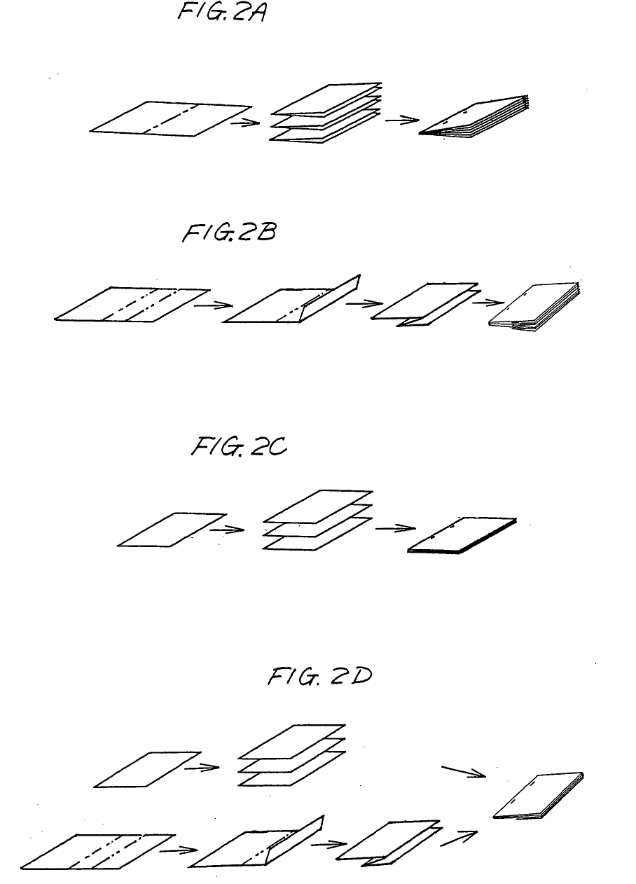

FIG. 2A, FIG. 2B, FIG. 2C and FIG. 2D illustrate examples of folding and binding sheets in the sheet binding apparatus 2. FIG. 2A illustrates a case that a sheet is folded at a single folding portion thereof (in the example, at the center portion of the sheet) and is bound at an edge portion thereof at the folded single folding portion side. FIG. 2B illustrates a case that a sheet is folded at two folding portions thereof to be like a letter Z in a cross section (in the example, at first at a portion of the sheet one-fourth of the length of the sheet from the leading edge of the sheet and secondly at a portion of the sheet one-fourth of the length of the sheet from the portion folded at first) and is bound at an edge portion thereof opposite the folded portions thereof. FIG. 2C illustrates a case that unfolded sheets are bound at their edge portions. FIG. 2D illustrates a case that a sheet folded at two folding portions thereof is mixed in unfolded sheets to be bound.

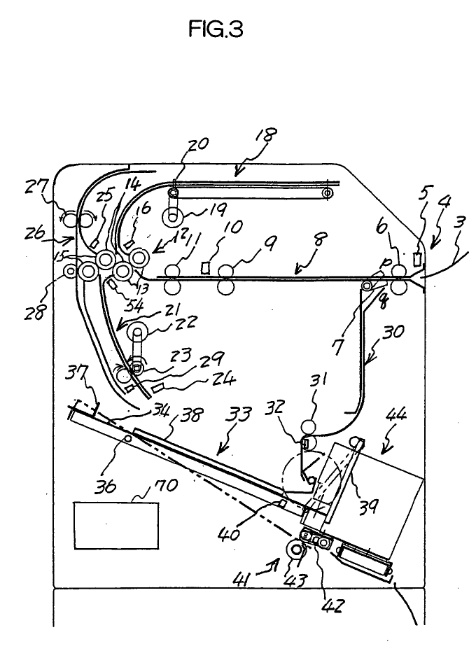

FIG. 3 schematically illustrates an exemplary construction of the sheet binding apparatus 2.

An entry part 4 serves as a receiving device of the present invention and is configured to receive a sheet 3 discharged from the image forming apparatus 1 and to convey the sheet 3 further. A first path 8 serves as a first conveying path of the present invention and is configured to guide and to convey the sheet 3 conveyed by the entry part 4. A folding part 12 serves as a folding device of the present invention and is configured to fold the sheet 3 conveyed by the first path 8 at a single folding portion or at two folding portions of the sheet 3 and to convey the sheet 3 further. A reversing part 26 arranged downstream of the folding part 12 serves as a reversing device of the present invention and is configured to reverse the sheet 3 conveyed from the folding part 12. A second path 30 serves as a second conveying path of the present invention and is configured to guide and to convey the sheet 3. A receiving/jogging part 33 including a tray 34 serves as a receiving/jogging device of the present invention and is configured to receive the sheet 3 conveyed by the folding part 12 one after another on the tray 34 and to jog the sheet 3 so as to be stacked into a stack of the sheet 3 on the tray 34. A binding part 44 arranged at an end of the tray 34 of the receiving/jogging part 33 serves as a binding device of the present invention and is configured to bind the stack of the sheet 3 on the tray 34 of the receiving/jogging part 33. A discharging part 41 serves as a discharge device of the present invention and is configured to discharge the bound stack of the sheet 3 on the tray 34 of the receiving/jogging part 33. A controller 70 is configured to receive an instruction from the image forming apparatus 1 and to control respective parts of the sheet binding apparatus 2 according to the received instruction.

The entry part 4 includes an entry sensor 5 configured to detect the sheet 3 discharged from the image forming apparatus 1 and entered into an opening part of the entry part 4, an entry roller pair 6 configured to receive the sheet 3 and to convey the sheet 3, and a sheet conveying path switching device 7 configured to switch the direction in which the sheet 3 conveyed by the entry roller pair 6 is conveyed between the first path 8 and the second path 30 according to detect information of the entry sensor 5 and the instruction received from the image forming apparatus 1.

The first path 8 is configured to convey the sheet 3 conveyed by the entry roller pair 6 to the folding part 12. The first path 8 includes a conveying roller pair 9 configured to convey the sheet 3 conveyed by the entry roller pair 6, a registration sensor 10 configured to detect the leading edge of the sheet 3 conveyed by the conveying roller pair 9, and a registration roller pair 11 configured to be intermittently driven by a control drive part (not shown) according to detect information of the registration sensor 10 to correct a deviation in the conveying direction of the sheet 3. After the leading edge of the sheet 3 has been detected with the registration sensor 10, a predetermined time later, the registration roller pair 11 is stopped to be rotated and after a predetermined time, is rotated again. The leading edge of the sheet 3 impinges upon the registration roller pair 11 stopped to be rotated, so that the sheet 3 is bulged between the registration roller pair 11 and the conveying roller pair 9 and thereby a deviation in the conveying direction of the sheet 3, such as skewing, is corrected. By correcting the deviation in the conveying direction of the sheet 3, the sheet 3 is folded by the folding part 12 in such a manner that the folded single folding portion and the folded two folding portions of the sheet 3 are perpendicular to the side edges of the sheet 3.

The folding part 12 includes a first roller pair 13 configured to convey the sheet 3 conveyed by the first conveying path 8, a first guide part 18 configured to guide the sheet 3 being conveyed by the first roller pair 13, a stopper plate 20 arranged in the first guide part 18 to serve as a stopping device of the present invention and is configured to stop the sheet 3 being conveyed by the first roller pair 13 and guided by the first guide part 18, a second roller pair 14 configured to fold the sheet 3 stopped by the stopper plate 20 at a portion of the sheet 3 and to convey the sheet 3, and a sensor 16 arranged at the entrance of the first guide part 18 to detect the leading edge of the sheet 3 conveyed by the first roller pair 13. The folding part 12 further includes a second guide part 21 configured to guide the sheet 3 being conveyed by the second roller pair 14, a roller pair 23 arranged in the second guide part 21 as a sheet stopping/conveying device of the present invention and is configured to stop and to convey the sheet 3 being conveyed by the second roller pair 14 and guided by the second guide part 21, a third roller pair 15 configured to fold the sheet 3 stopped by the roller pair 23 at another portion of the sheet 3 and to convey the sheet 3, and a sensor 54 arranged at the entrance of the second guide part 21 to detect the leading edge of the sheet 3 conveyed by the second roller pair 14.

The second guide part 21 is configured to guide the sheet 3 being conveyed by the second roller pair 14 and conveyed by the roller pair 23 further to be discharged directly onto the tray 34 of the receiving/jogging part 33 from the end side of the tray 34 opposite the end side thereof where the binding part 44 is arranged.

The first roller pair 13, the first guide part 18, the stopper plate 20, and the second roller pair 14 constitute a first folding part of the present invention, and the second roller pair 14, the second guide part 21, the roller pair 23, and the third roller pair 15 constitute a second folding part of the present invention. When folding the sheet 3 received by the entry part 4 at a single folding portion of the sheet 3 according to the instruction from the image forming apparatus 1, the sheet 3 is folded by the first folding part at the single folding portion of the sheet 3 and is conveyed by the first folding part to the second folding part, and thereafter, the sheet 3 is discharged by the second folding part directly onto the tray 34 of the receiving/jogging part 33. When folding the sheet 3 received by the entry part 4 at two folding portions of the sheet 3, the sheet 3 is folded by the first folding part at a first folding portion of the two folding portions thereof and is conveyed by the first folding part to the second folding part, and thereafter, the sheet 3 is folded by the second folding part at a second folding portion of the two folding portions thereof.

The first guide part 18 includes two guide plates arranged to form a sheet path, through which the sheet 3 conveyed by the first roller pair 13 is conveyed. The stopper plate 20 is provided to a belt arranged below the guide plates and protrudes the guide plates through grooves provided in the guide plates to stop the sheet 3 being conveyed in the sheet path of the second guide part 18. The stopper plate 20 is configured to be moved in the grooves of the guide plates by driving of the belt with a stepping motor 19, and is moved, according to the instruction received from the image forming apparatus 1, to a stopping position to regulate the leading edge of the sheet 3 being conveyed by the first roller pair 13 and guided by the first guide part 18 and to thereby stop the sheet 3.

When the leading edge of the sheet 3 being conveyed by the first roller pair 13 and guided by the first guide part 18 has impinged upon the stopper plate 20, the sheet 3 is caused to bulge at a portion thereof located between the nip of the first roller pair 13 and the entrance of the sheet path formed by the two guide plates of the first guide part 18 toward the nip of the second roller pair 14. The bulged portion of the sheet 3 is pinched in the nip of the second roller pair 14 and thereby the sheet 3 is folded by the second roller pair 14 at the bulged portion of the sheet 3 pinched in the second roller pair 14. The sheet 3 is conveyed to the second guide part 21 with the second roller pair 14 with the folded portion of the sheet 3 placed as the leading edge of the sheet 3.

The position where the stopper plate 20 is moved to regulate the leading edge of the sheet 3 being conveyed by the first roller pair 13 and guided by the first guide part 18 to stop the sheet 3 is determined based upon the position of the folding portion of the sheet 3 included in the instruction from the image forming apparatus 1. In folding the sheet 3 at a single folding portion thereof, when the single folding portion of the sheet 3 is the center portion of the sheet 3, for example, the stopper plate 20 is moved to the position separate from the nip of the first roller pair 13 by the distance corresponding to the half of the length of the sheet 3 in the direction in which the sheet 3 is conveyed, and thereby the sheet 3 is folded by the second roller pair 14 at the center portion of the sheet 3. In folding the sheet 3 at two folding portions thereof, when the first folding portion of the two folding portions of the sheet 3 is the portion of the sheet 3 one-fourth of the length of the sheet 3 from the leading edge thereof, for example, the stopper plate 20 is moved to the position separate from the nip of the first roller pair 13 by the distance corresponding to one-fourth of the length of the sheet 3, and thereby the sheet 3 is folded by the second roller pair 14 at the portion one-fourth of the length of the sheet 3 from the leading edge thereof.

A roller pair arranged in a fixed position may be used, instead of the stopper plate 20, as the stopping device to stop the sheet 3 being conveyed by the first roller pair 13 and guided by the first guide part 18. The roller pair is rotated to convey the sheet 3 being conveyed by the first roller pair 13 and guided by the first guide part 18 and is rotated in reverse to stop the sheet 3. When folding the sheet 3 at two folding portions thereof, the roller pair is rotated in reverse after detecting the leading edge of the sheet 3 with the sensor 16 in the timing that the sheet 3 has been conveyed by the first roller pair 13 the distance corresponding to the length of the sheet 3 from the leading edge to the first folding portion of the two folding portions of the sheet 3, so that the sheet 3 is caused to bulge at the first folding portion thereof located between the nip of the first roller pair 13 and the entrance of the sheet path formed by the two plates of the first guide part 18 toward the nip of the second roller pair 14, the bulged first folding portion of the sheet 3 is pinched in the nip of the second roller pair 14, and thereby the sheet 3 is folded by the second roller pair 14 at the first folding portion thereof and is conveyed further. When folding the sheet 3 at a single folding portion thereof, the roller pair is rotated in reverse in the timing that the sheet 3 has been conveyed by the first roller pair 13 the distance corresponding to the length of the sheet 3 from the leading edge to the single folding portion thereof and thereby the sheet 3 is similarly folded by the second roller pair 14 at the single folding portion thereof.

The second guide part 21 includes two guide plates arranged to form a sheet path, through which the sheet 3 conveyed by the second roller pair 14 is conveyed. Grooves are formed in the guide plates, and the roller pair 23 arranged in the second guide part 21 is configured to be moved in the grooves to a stopping position according to the instruction received from the image forming apparatus 1 to regulate the leading edge of the sheet 3 being conveyed by the second roller pair 14 and guided by the second guided part 21 to stop the sheet 3.

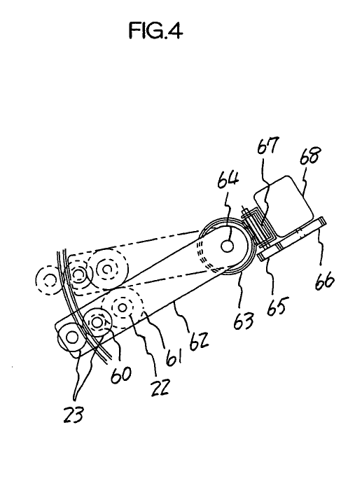

FIG. 4 illustrates an exemplary mechanism of moving the roller pair 23. The guide plates of the second guide part 21 are attached to side plates of the main body of the binding apparatus 2. The roller pair 23 is rotatably mounted to a plate 62 fixed to an axis 64, which is rotatably supported by bearings at parts of the side plates of the main body corresponding to the center of an arc of the guide plates. The roller pair 23 is rotated, is stopped to be rotated, and is rotated in reverse by driving of a gear 61 and a gear 60 with a stepping motor 22 fixed to the plate 62. A gear 63 integrated with the plate 62 is fixed to an axis 64 rotatably supported with bearings at the side plates of the main body, and is engaged with a worm gear 67. The worm gear 67 is driven by driving of a gear 65 engaging with a gear 66 fixed to an axis of a stepping motor 68 mounted to the side plates of the main body. The roller pair 23 is moved with driving of the gears 66, 65, 67 and 63 by the stepping motor 68.

When folding the sheet 3 at two folding portions thereof, the roller pair 23 is moved to a stopping position separate from the nip of the second roller pair 14 by the distance corresponding to the length of the sheet 3 from the first folding portion to the second folding portion of the two folding portions of the sheet 3, and is stopped to be rotated to regulate the leading edge (the folded first folding portion) of the sheet 3 folded at the first folding portion and being conveyed by the second roller pair 14 and guided by the second guide part 21, so that the sheet 3 is stopped in the timing that the sheet 3 has been conveyed by the second roller pair 14 by the distance corresponding to the length of the sheet 3 from the first folding portion to the second folding portion of the sheet 3. Thereby, the second folding portion of the sheet 3 located between the entrance of the sheet path of the second guide part 21 and the nip of the third roller pair 15 is caused to bulge toward the nip of the third roller pair 15, the bulged second folding portion of the sheet 3 is pinched in the nip of the third roller pair 15, and thereby the sheet 3 is folded by the third roller pair 15 at the second folding portion of the sheet 3. The sheet 3 is conveyed by the third roller pair 15 with the folded second folding portion thereof placed as the leading edge of the sheet 3 to the reversing part 26 arranged downstream of the third roller pair 15.

When folding the sheet 3 at a single folding portion thereof, the roller pair 23 is moved to a predetermined conveying position and is rotated in the arrow direction in FIG. 3 to convey the sheet 3 folded at the single folding portion thereof and being conveyed by the second roller pair 14 and guided by the second guide part 21 further, without stopping the sheet 3, so that the sheet 3 folded at the single folding portion thereof is conveyed by the roller pair 23 to be discharged onto the tray 34 of the receiving/jogging part 33 with the folded single folding portion thereof placed as the leading edge of the sheet 3 from the end side of the tray 34 opposite the end side thereof where the binding part 44 is arranged. Thereby, the sheet 3 folded at the single folding portion thereof is received on the tray 34 of the receiving/jogging part 33 with the folded single folding portion thereof located at the end side of the tray 34 where the binding part 44 is arranged, so that the sheet 3 is bound by the binding part 44 at the edge portion thereof at the folded single folding portion side.

The roller pair 23 may be alternatively fixed. When folding the sheet 3 at two folding portions thereof, the roller pair 23 is rotated in the arrow direction in FIG. 3 to convey the sheet 3 folded at the first folding portion thereof and being conveyed by the second roller pair 14 and guided by the second guide part 21 and is rotated in reverse in the timing that the sheet 3 has been conveyed by the second roller pair 14 the distance corresponding to the length of the sheet 3 from the first folding portion to the second folding portion of the sheet 3. Thereby, the second folding portion of the sheet 3 located between the entrance of the sheet path of the second guide part 21 and the nip of the third roller pair 15 is caused to bulge toward the nip of the third roller pair 15, the bulged second folding portion of the sheet 3 is pinched in the nip of the third roller pair 15, and thereby the sheet 3 is folded by the third roller pair 15 at the second folding portion of the sheet 3. The sheet 3 is conveyed by the third roller pair 15 with the folded second folding portion thereof placed as the leading edge thereof to the reversing part 26 arranged downstream of the third roller pair 15. When folding the sheet 3 at a single folding portion thereof, the roller pair 23 is rotated in the arrow direction in FIG. 3 to convey the sheet 3 folded at the single folding portion thereof and being conveyed by the second roller pair 14 and guided by the second guide part 21 further, without stopping the sheet 3. Thereby, the sheet 3 folded at the single folding portion thereof is conveyed by the roller pair 23 and is discharged onto the tray 34 of the receiving/jogging part 33.

The reversing part 26 includes a sheet path into which the sheet 3 conveyed by the third roller pair 15 with the folded second folding portion of the sheet 3 placed as the leading edge thereof is conveyed, a sensor 25 arranged at the entrance of the sheet path, and a guide roller pair 27 arranged along the sheet path. The guide roller pair 27 starts to rotate in the arrow direction in FIG. 3 upon detecting the leading edge of the sheet 3 conveyed from the third roller pair 15 with the sensor 25 to convey the sheet 3 into the sheet path. Upon detecting the trailing edge of the sheet 3 with the sensor 25, the guide roller pair 27 is rotated in reverse, so that the sheet 3 is reversed by the guide roller pair 27 to be conveyed with the end thereof opposite the folded second folding portion thereof placed as the leading edge of the sheet 3. The reversing part 26 includes a roller pair 28 arranged to convey the sheet 3 reversed by the guide roller pair 27 further and a sheet path arranged downstream of the roller pair 28 to guide the sheet 3 conveyed by the roller pair 28 to be discharged onto the tray 34 of the receiving/jogging part 33 from the end side of the tray 34 opposite the end side thereof where the binding part 44 is arranged, so that the sheet 3 folded at the two folding portions thereof is received on the tray 34 of the receiving/jogging part 33 with the end thereof opposite the folded second folding portion thereof located at the end side of tray 34 where the binding part 44 is arranged. Thereby, the sheet 3 folded at the two folding portions thereof is bound by the binding part 44 at the edge portion thereof opposite the folded second folding portion thereof.

A sensor 29 is arranged at the end of the sheet path arranged downstream of the roller pair 28 to detect the leading edge of the sheet 3 conveyed by the roller pair 28.

The second conveying path 30 is configured to guide the sheet 3 conveyed by the entry roller pair 6 and guided by the switching member 7 to be conveyed thereto to be directly discharged onto the tray 34 of the receiving/jogging part 33 as an unfolded sheet from the end side of the tray 34 where the binding part 44 is arranged. A discharge roller pair 31 is arranged at the end of the second conveying path 30 to discharge the sheet 3 onto the tray 34, and a discharge sensor 32 is arranged to detect the trailing edge of the sheet 3.

The receiving/jogging part 33 includes an end plate 37 arranged at the end side of the tray 34 opposite the end thereof where the binding part 44 is arranged. The end plate 37 is driven by a stepping motor (not shown) to reciprocate in the direction in which the sheet 3 is discharged onto the tray 34 from the second guide part 21 and the reversing part 26 to jog the sheet 3 in the conveying direction of the sheet 3. A side plate (not shown) is arranged at the rear side of the tray 34 in the widthwise direction of the tray 34, and a side guide plate 38 is arranged at this side of the tray 34 in the widthwise direction of the tray 34 and is driven by a stepping motor (not shown) to reciprocate in the widthwise direction of the tray 34 to jog the sheet 3 in the widthwise direction thereof.

The binding part 44 is arranged at the tip end of the tray 34 of the receiving/jogging part 33 in the direction in which the sheet 3 is discharged onto the tray 34 from the second guide part 21 and the reversing part 26. The binding part 44 includes a stopping plate 39, against which the sheet 3 discharged onto the tray 34 is jogged by the end plate 37 so that the leading edge of the sheet 3 discharged from the second guide part 21 and the reversing part 26 is aligned with the stopping plate 39, and a binding device (not shown) configured to bind a stack of the sheet 3 on the tray 34. A known device, such as a stapler, etc., may be used for the binding device. Further, a plurality of binding devices may be arranged.

The discharge part 41 includes an arm mechanism (not shown) configured to move the stopping plate 39 of the binding part 44 toward the end plate 37 of the receiving/jogging part 33 after the stack of the sheet 3 on the tray 34 has been bound by the binding device of the binding part 44. After the stopping plate 39 has been moved toward the end plate 37 and thereby the stack of the sheet 3 on the tray 34 has been pushed toward the end plate 37, the edge side of the tray 34 at the side of the binding part 44 is lowered to the position indicated by a two-dot-dashed line in FIG. 3 with an axis 36 at the other end side of the tray 34 serving as a fulcrum, so that the stack of sheet 3 on the tray 34 is moved toward a discharge roller pair 43 arranged under the binding part 44, and is conveyed by the discharge roller pair 43 to a discharge tray (not shown). A sheet detect sensor 40 is arranged under the tray 34 to detect existence of the stack of the sheet 3 on the tray 34, and a sensor 42 is arranged near the discharge roller pair 43 to detect discharging of the stack of the sheet 3 from the tray 34.

The receiving/jogging part 33 may be configured such that the end side of the tray 34 at the side of the end plate 37 is lowered so that the stack of the sheet 3 on the tray 34 is discharged to the side opposite the binding part 44.

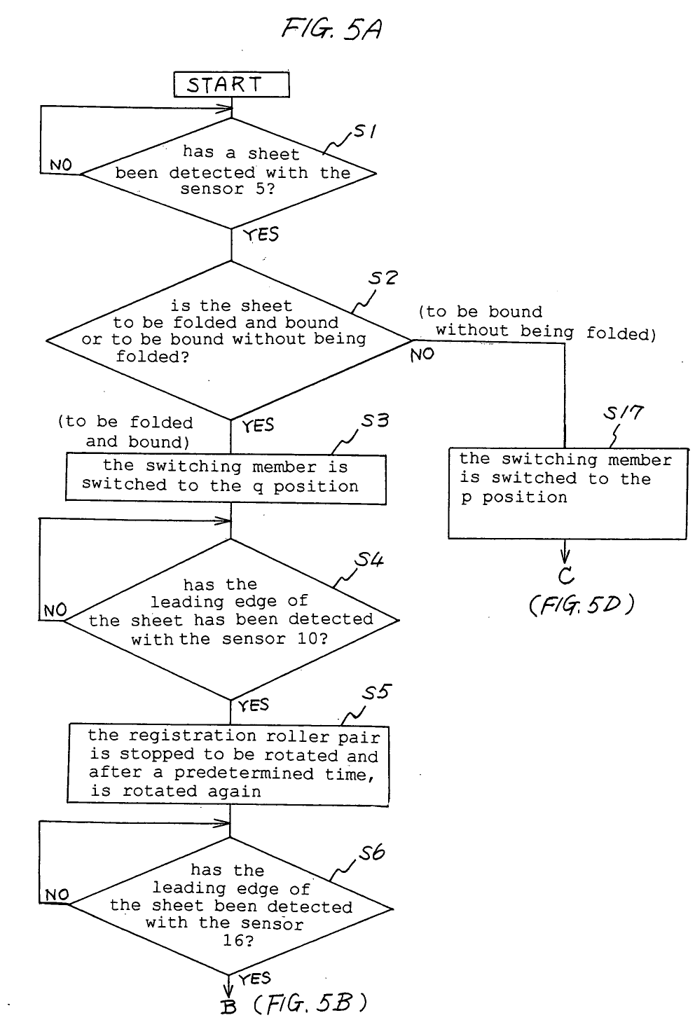

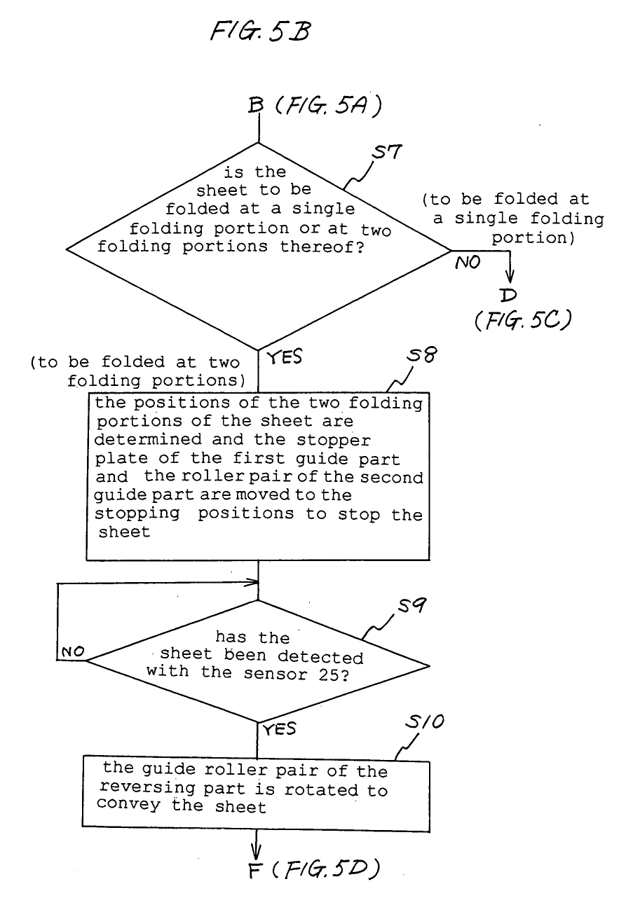

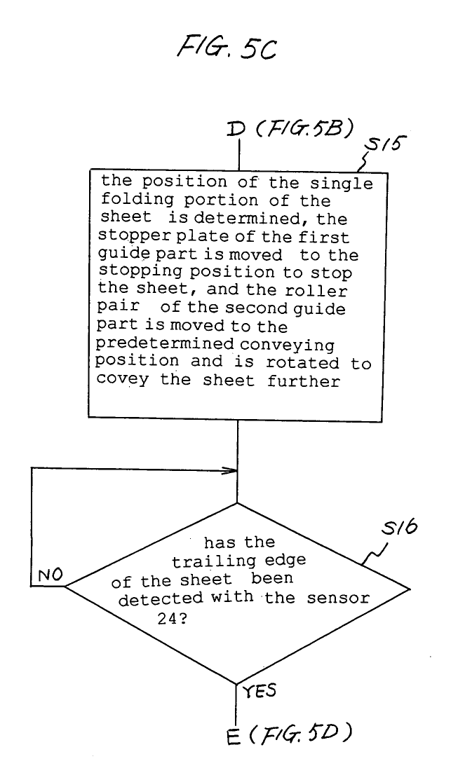

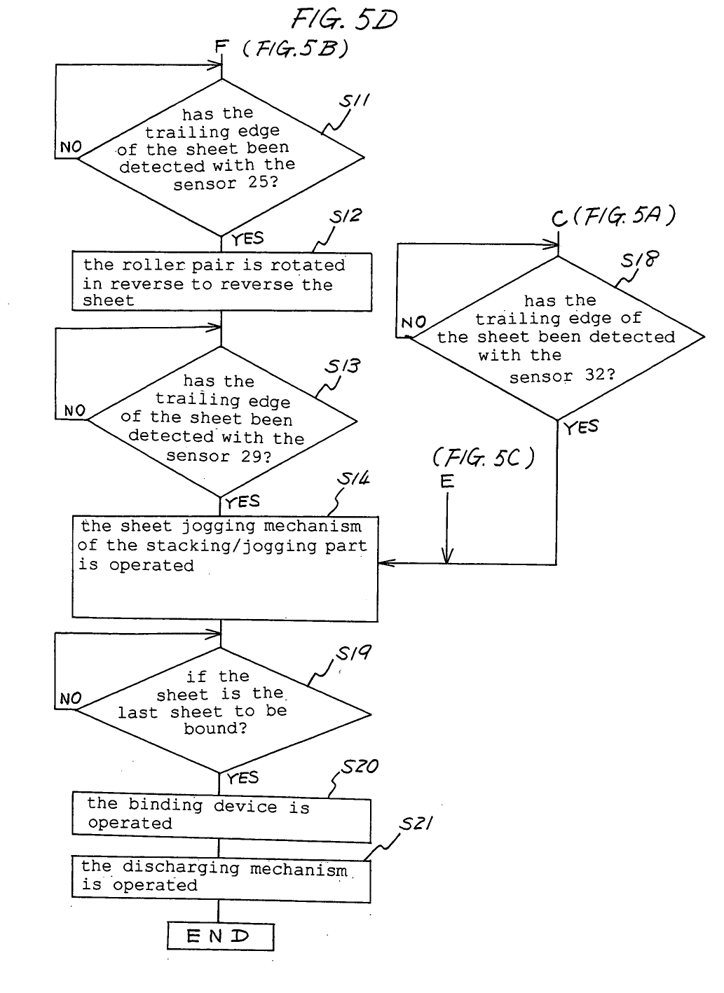

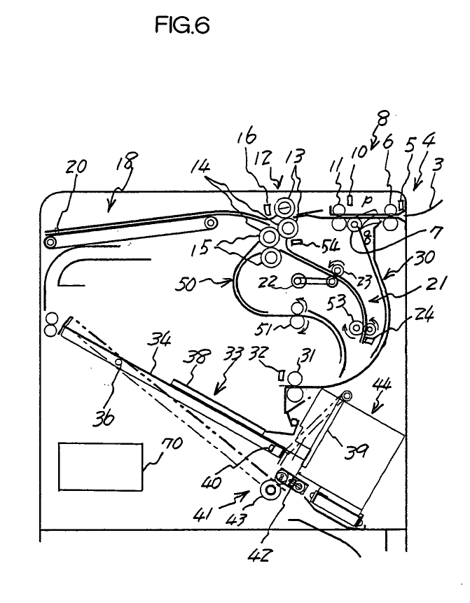

FIG. 5A through FIG. 5D illustrate a flowchart of an exemplary operation of the binding apparatus 2.

When the binding apparatus 2 is turned on, the entry roller pair 6 of the entry part 4, the conveying roller pair 9 and the registration roller pair 11 of the first path 8, the first roller pair 13, the second roller pair 14 and the third roller pair 15 of the folding part 12, and the discharge roller pair 31 of the second path 30 start to rotate. The switching member 7 of the entry part 4 is moved to the p position in which the sheet 3 conveyed by the entry roller pair 6 is conveyed to the second path 30, the tray 34 of the receiving/jogging part 33 is moved to the upper position (indicated by a solid line in FIG. 3), and the end plate 37 and the side guide plate 38 of the receiving/jogging part 33 are moved to respective start positions (the most outside positions).

When the sheet 3 discharged from the image forming apparatus 1 and put into the opening of the entry part 4 of the binding apparatus 2 is detected with the entry sensor 5 (Yes in step S1), whether the sheet 3 is to be folded and bound or to be bound, without being folded, is determined according to the instruction received from the image forming apparatus 1 (step S2). When it has been determined in step S2 that the sheet 3 is to be folded and bound, the switching member 7 is switched to the q position (step S3), so that the sheet 3 is conveyed to the first path 8.

The sheet 3 conveyed to the first path 8 is conveyed with the conveying roller pair 9, and when the leading edge of the sheet 3 has been detected by the sensor 10 (Yes in step S4), after a predetermined time, the registration roller pair 11 is stopped to be rotated and after a predetermined time, is rotated again (step S5). By such an intermittent motion of the registration roller pair 11, a deviation in the conveying direction of the sheet 3, such as skewing, is corrected, and thereby precise folding and binding of the sheet 3 is realized.

Thereafter, the sheet 3 is conveyed with the first roller pair 13 to the first guide part 18. When the leading edge of the sheet 3 has been detected with the sensor 16 (Yes in step S6), whether the sheet 3 is to be folded at a single folding portion (in two-folding) or at two folding portions thereof (in Z-folding) is determined according to the instruction received from the image forming apparatus 1 (step S7).

When it has been determined in step S7 that the sheet 3 is to be folded at two folding portions thereof (in Z-folding), the positions of the two folding portions of the sheet 3 are determined according to the instruction received from the image forming apparatus 1, and the stopper plate 20 of the first guide part 18 is moved by driving of the stepping motor 19 to the position separate from the nip of the first roller pair 13 by the distance corresponding to the length of the sheet 3 from the leading edge to the first folding portion of the two folding portions of the sheet 3 and the roller pair 23 of the second guide part 21 is moved to the stopping position separate from the nip of the second roller pair 14 by the distance corresponding to the length of the sheet 3 from the first folding portion to the second folding portion of the sheet 3 and is stopped to be rotated (step S8). Thereby, the sheet 3 being conveyed by the first roller pair 13 is stopped in the timing that the sheet 3 has been conveyed by the first roller pair 13 the distance corresponding to the length of the sheet 3 from the leading edge to the first folding portion of the sheet 3, so that the sheet 3 is folded by the second roller pair 14 at the first folding portion of the two folding portions thereof and is conveyed by the second roller pair to the second guide part 21, and thereafter, the sheet 3 being conveyed by the second roller pair 14 is stopped in the timing that the sheet 3 has been conveyed by the second roller pair 14 by the distance corresponding to the length of the sheet 3 from the first folding portion to the second folding portion of the sheet 3, so that the sheet 3 is folded by the third roller pair 15 at the second folding portion thereof and is conveyed by the third roller pair 15 to the reversing part 26. The stopper plate 20 and the roller pair 23 may be moved in advance to respective stopping positions.

When the leading edge of the sheet 3 folded at the second folding portion thereof and conveyed by the third roller pair 15 has been detected by the sensor 25 (Yes in step S9), the guide roller pair 27 of the reversing part 26 is rotated in the arrow direction in FIG. 3 (step S10), so that the sheet 3 is conveyed into the sheet path of the reversing part 26. When the trailing edge of the sheet 3 has been detected by the sensor 25 (Yes in step S11), the roller pair 27 is rotated in reverse (step S12), so that the sheet 3 is reversed to the roller pair 28 and is conveyed by the roller pair 28 to be discharged onto the tray 34 of the receiving/jogging part 33. When the trailing edge of the sheet 3 has been detected with the sensor 29 (Yes in step S13), the sheet jogging mechanism (the end plate 37, etc.) of the receiving/jogging part 33 is operated (step S14).

When it has been determined in step S7 that the sheet 3 is to be folded at a single folding portion thereof (in two-folding), the position of the single folding portion of the sheet 3 is determined according to the instruction received from the image forming apparatus 1, and the stopper plate 20 of the first guide part 18 is moved by driving of the stepping motor 19 to the position separate from the nip of the first roller pair 13 by the distance corresponding to the length of the sheet 3 from the leading edge to the single folding portion of the sheet 3 and the roller pair 23 of the second guide part 21 is moved to the predetermined conveying position and is rotated in the arrow direction in FIG. 3 (step S15). Thereby, the sheet 3 being conveyed by the first roller pair 13 is stopped by the stopper plate 20 in the timing that the sheet 3 has been conveyed by the first roller pair 13 by the distance corresponding to the length of the sheet 3 from the leading edge to the single folding portion of the sheet 3, so that the sheet 3 is fold by the second roller pair 14 at the single folding portion thereof and is conveyed by the second roller pair 14 to the second guide part 21 and thereafter, the sheet 3 is conveyed by the roller pair 23 rotating in the arrow direction in FIG. 3 and is guided by the second guide part 21 to be discharged onto the tray 34 of the receiving/jogging part 33. When the trailing edge of the sheet 3 has been detected with the sensor 24 (Yes in step S16), the jogging mechanism of the receiving/jogging part 33 is operated (step S14).

When it has been determined in step S2 that the sheet 3 is to be bound without being folded, the switching member 7 is switched to the p position (step S17), so that the sheet 3 is conveyed to the second path 30. The sheet 3 is conveyed by the discharge roller pair 31 and is discharged onto the tray 34 of the receiving/jogging part 33 as an unfolded sheet. When the trailing edge of the sheet 3 has been detected with the sensor 32 (Yes in step S18), the jogging mechanism of the receiving/jogging 33 is operated (step S14).

The sheet 3 discharged onto the tray 34 of the receiving/jogging part 33 from the reversing part 26 or the second guide part 21 impinges upon the stopping plate 39 of the binding part 44 and is aligned with the stopping plate 39 by the reciprocating movement of the end plate 37 of the receiving/jogging part 33 against the stopping plate 39. The sheet 3 is also aligned with the side plate of the receiving/jogging part 33 at the rear side of the tray 34 in the widthwise direction of the tray 34 by the reciprocating movement of the side guide plate 38 against the side plate.

The sheet 3 discharged onto the tray 34 of the receiving/jogging part 33 from the second path 30 impinges upon the end plate 37 and aligned with the stopping plate 39 by the reciprocating movement of the end plate 37 in a similar manner.

Thereafter, it is determined if the sheet 3 discharged onto the tray 34 of the receiving/jogging part 33 is the last sheet to be bound or if a predetermined number of the sheet 3 has been discharged onto tray 34, according to the instruction received from the image forming apparatus 1 (step S19). When it has been determined that the sheet 3 is the last sheet to be bound or the predetermined number of the sheet 3 has been discharged onto the tray 34 of the receiving/jogging part 33 (Yes in step S19), the end plate 37 is moved to the jogging position at the side of the binding part 44 and the side guide plate 38 is moved to the jogging position at the side of the side plate, and the binding device of the binding part 44 is operated to bind the stack of the sheet 3 on the tray 34 of the receiving/jogging part 33 (step S20).

Thereafter, the discharging mechanism (the arm mechanism of the discharge part 41, etc.) is operated to discharge the bound stack of the sheet 3 on the tray 34 to the discharge tray (step S21). Specifically, the arm mechanism of the discharge part 41 moves the stopping plate 39 and the end plate 37 toward the end side of the tray 34 opposite the end thereof where the binding part 44 is arranged, so that the stack of the sheet 3 on the tray 34 is moved toward the end side of the tray 34 opposite the end thereof where the binding part 44 is arranged a predetermined distance. Thereafter, when the sensor 40 has detected the existence of the stack of the sheet 3 on the tray 34, the tray 34 is lowered to the position indicated by the two-dot-dashed line in FIG. 3, and the end plate 37 moves to push the stack of the sheet 3 on the tray 34 to the discharge part 41. Further, when the stack of the sheet 3 has been detected with the sensor 42, the discharge roller pair 43 starts to rotate, so that the stack of the sheet 3 is discharged to the discharge tray.

FIG. 6 illustrates a construction of the binding apparatus 2 according to another embodiment of the present invention.

In the binding apparatus 2 of the previous embodiment, as described above, the sheet 3 folded at a single folding portion thereof and the sheet 3 folded at two folding portions thereof are discharged onto the tray 34 of the receiving/jogging part 33 from the end side of the tray 34 opposite the end side thereof where the binding part 44 is arranged. Thereby, the sheet 3 folded at the single folding portion thereof is received on the tray 34 of the receiving/jogging part 33 with the folded single folding portion thereof located at the end side of the tray 34 where the binding part 44 is arranged, so that the sheet 3 folded at the single folding portion thereof is bound by the binding device of the binding part 44 at the edge portion thereof at the folded single folding portion side, and the sheet 3 folded at the two folding portions thereof is received on the tray 34 with the end of the sheet 3 opposite the folded second folding portion thereof located at the end side of the tray 34 where the binding part 44 is arranged, so that the sheet 3 folded at the two folding portions thereof is bound by the binding device of the binding part 44 at the edge portion thereof opposite the folded second folding portion thereof. On the other hand, the binding apparatus 2 of this embodiment is configured such that the sheet 3 folded at a single folding portion thereof and the sheet 3 folded at two folding portions thereof are discharged onto the tray 34 of the receiving/jogging part 33 from the end side of the tray 34 where the binding part 44 is arranged.

In the binding apparatus 2 of this embodiment, as illustrated in FIG. 6, the second guide part 21 is configured to guide the sheet 3 folded at a single folding portion thereof and conveyed by the second roller pair 14 to be discharged onto the tray 34 of the receiving/jogging part 33 from the end side of the tray 34 where the binding part 44 is arranged. More specifically, the second guide part 21 is configured to guide the sheet 3 folded at the single folding portion thereof to be discharged onto a downstream side portion of the second path 30. Further, the roller pair 23 fixed in a position is used for the stopping/conveying device stopping and conveying the sheet 3 being conveyed by the second roller pair 14 and guided by the second guide part 21, and a relaying roller pair 53 is arranged at the end of the second guide part 21 to discharge the sheet 3 onto the downstream side portion of the second path 30. The sheet 3 folded at the single folding portion thereof, which has been discharged onto the downstream side portion of the second path 30 from the second guide part 21, is discharged by the discharge roller pair 31 of the second path 30 onto the tray 34 of the receiving/jogging part 33 from the end side of the tray 34 where the binding part 44 is arranged.

Further, a discharge path 50 is arranged downstream of the third roller pair 15 to convey the sheet 3 folded at two folding portions thereof and conveyed by the third roller pair 15 to be discharged onto the tray 34 of the receiving/jogging part 33 from the end side of the tray 34 where the binding part 44 is arranged. More specifically, the discharge path 50 includes a relaying roller pair 51 to convey the sheet 3 conveyed by the third roller pair 15 and is configured to guide the sheet 3 conveyed by the third roller pair 15 and the relaying roller pair 51 to be discharged onto an end portion of the second path 30 near the exit thereof. The sheet 3 folded at the two folding portions thereof, which has been discharged onto the end portion of the second path 30 from the discharge path 50, is discharged by the discharge roller pair 31 of the second path 30 onto the tray 34 of the receiving/jogging part 33 from the end side of the tray 34 where the binding part 44 is arranged.

Furthermore, the second guide part 21 is configured to reverse the sheet 3 folded at a single folding portion thereof and conveyed by the second roller pair 14 with the folded single folding portion thereof placed as the leading edge of the sheet 3 to the third roller pair 15 so that the sheet 3 folded at the single folding portion thereof is conveyed by the third roller pair 15 to the discharge path 50 with the end of the sheet 3 opposite the folded single folding portion thereof placed as the leading edge of the sheet 3. When reversing the sheet 3 folded at the single folding portion thereof to the third roller pair 15, the roller pair 23 and the relaying roller pair 53 arranged at the end of the second guide part 21 start to rotate in reverse upon detecting the trailing edge of the sheet 3 conveyed by the second roller pair 14 with the sensor 54, and thereby the sheet 3 is reversed to the third roller pair 15.

In folding the sheet 3 at a single folding portion thereof, when the sheet 3 is folded at the center portion thereof, for example, and the sheet 3 is to be bound at the edge portion of the sheet 3 opposite the folded center portion thereof, the sheet 3 folded at the center portion thereof and conveyed by the second roller pair 14 to the second guide part 21 is conveyed by the roller pair 23 further and is guided by the second guide part 21 to be discharged onto the downstream side portion of the second path 30. The sheet 3 is then discharged by the discharge roller pair 31 of the second path 30 onto the tray 34 of the receiving/jogging part 33 from the end side of the tray 34 where the binding part 44 is arranged. Thereby, the sheet 3 folded at the center portion thereof is received on the tray 34 with the end of the sheet 3 opposite the folded center portion thereof located at the end side of the tray 34 where the binding part 44 is arranged, so that the sheet 3 is bound by the binding device of the binding part 44 at the edge portion of the sheet 3 opposite the folded center portion thereof.

When the sheet 3 folded at the center portion thereof is to be bound at the edge portion of the sheet 3 at the folded center portion side, the sheet 3 is reversed by the second guide part 21 to the third roller pair 15, and the sheet 3 is conveyed by the third roller pair 15 to the discharge path 50, so that the sheet 3 is guided by the discharge path 50 to be discharged onto the end portion of the second path 30 and is discharged by the discharge roller pair 31 of the second path 30 onto the tray 34 of the receiving/jogging part 33 from the end side of the tray 34 where the binding part 44 is arranged. Thereby, the sheet 3 folded at the center portion thereof is received on the tray 34 of the receiving/jogging part 33 with the folded center portion thereof located at the end side of the tray 34 where the binding part 44 is arranged, so that the sheet 3 is bound by the binding device of the binding part 44 at the edge portion thereof at the folded center portion side.

Further, the binding apparatus 2 of this embodiment is configured such that the sheet 3 conveyed to the folding part 12 is reversed by the first guide part 18 to the second guide part 21 as an unfolded sheet and the sheet 3 is then conveyed by the second guide part 21 further. Thereby, the sheet 3 is received on the tray 34 of the receiving/jogging part 33 as an unfolded sheet with the leading edge and the trailing edge of the sheet 3 when the sheet 3 has been received by the entry part 8 and conveyed to the folding part 12 reversed.

When the sheet 3 received by the entry part 4 is to be bound, without being folded, at the edge portion thereof at the trailing edge side of the sheet 3, the sheet 3 is conveyed to the second path 30. Thereby, the sheet 3 is received on the tray 34 of the receiving/jogging part 33 with the trailing edge thereof located at the end side of the tray 34 where the binding part 44 is arranged, so that the sheet 3 is bound by the binding device of the binding part 44 at the edge portion thereof at the trailing edge side.

When the sheet 3 received by the entry part 4 is to be bound, without being folded, at the edge portion thereof at the leading edge side of the sheet 3, the sheet 3 is conveyed to the first path 8 and is conveyed to the first guide part 18. The stopper plate 20 is moved to a reversing position corresponding to the length of the sheet 3 in the direction in which the sheet 3 is conveyed by the entry part 4, and when the trailing edge of the sheet 3 conveyed by the first roller pair 13 has been detected with the sensor 16, the stopper plate 20 pushes back the sheet 3 toward the second roller pair 14, so that the sheet 3 is conveyed by the second roller pair 14 to the second guide part 21 as an unfolded sheet, and the sheet 3 is further conveyed by the roller pair 23 and the relaying roller pair 53 rotating in the arrow direction in FIG. 6 to be discharged onto the downstream side portion of the second path 30. The sheet 3 is then discharged by the discharge roller pair 31 of the second path 30 onto the tray 34 of the receiving/jogging part 33 as an unfolded sheet from the end side of the tray 34 where the binding part 44 is arranged. Thereby, the sheet 3 is received on the tray 34 of the receiving/jogging part 33 with the leading edge thereof when the sheet 3 has been received by the entry part 4 located at the end side of the tray 34 where the binding part 44 is arranged, so that the sheet 3 is bound by the binding device of the binding part 44 at the edge portion thereof at the leading edge side when the sheet 3 has been received by the entry part 4.

When folding the sheet 3 conveyed by the entry part 4 at two folding portions thereof, the sheet 3 is folded by the second roller pair 14 at the first folding portion of the two folding portions thereof and by the third roller pair 15 at the second folding portion of the two folding portions thereof as in the previous embodiment, and the sheet 3 folded at the first folding portion and the second folding portion thereof is conveyed by the third roller pair 15 to the discharge path 50. The sheet 3 is conveyed by the relaying roller pair 51 and is guided by the discharge path 50 to be discharged onto the end portion of the second path 30. The sheet 3 is then discharged by the discharge roller pair 31 of the second path 30 onto the tray 34 of the receiving/jogging part 33 from the end side of the tray 34 where the binding part 44 is arranged. Thereby, the sheet 3 is received on the tray 34 of the receiving/jogging part 33 with the end of the sheet 3 opposite the folded second folding portion thereof located at the end side of the tray 34 where the binding part 44 is arranged, so that the sheet 3 is bound by the binding device of the binding part 44 at the edge portion thereof opposite the folded second folding portion thereof as in the previous embodiment.

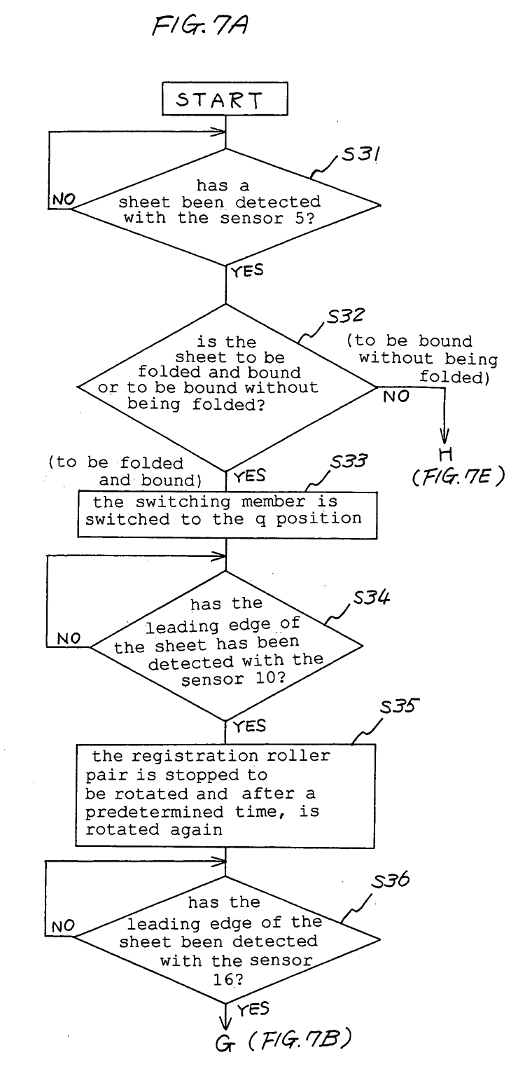

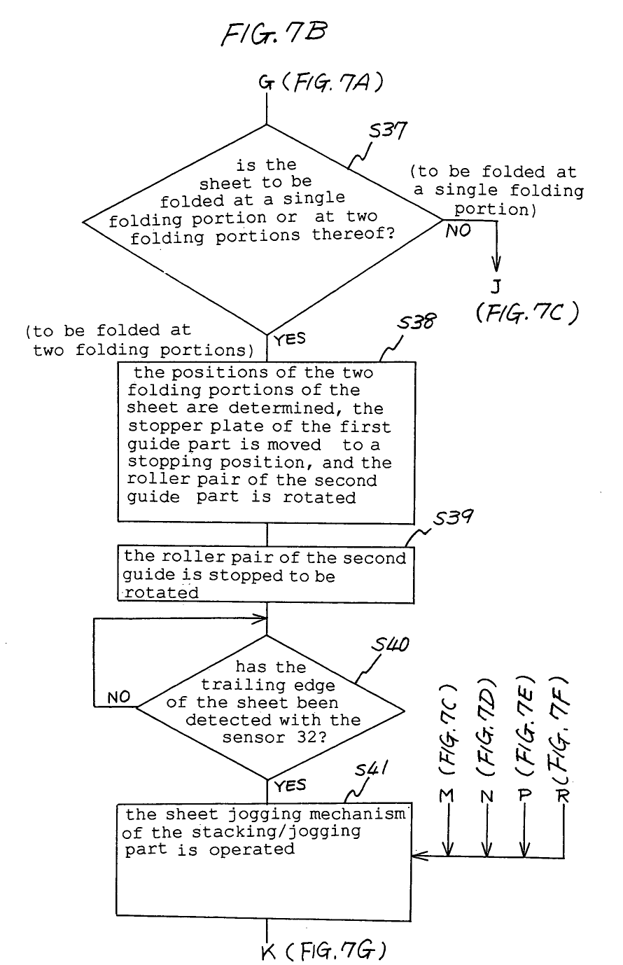

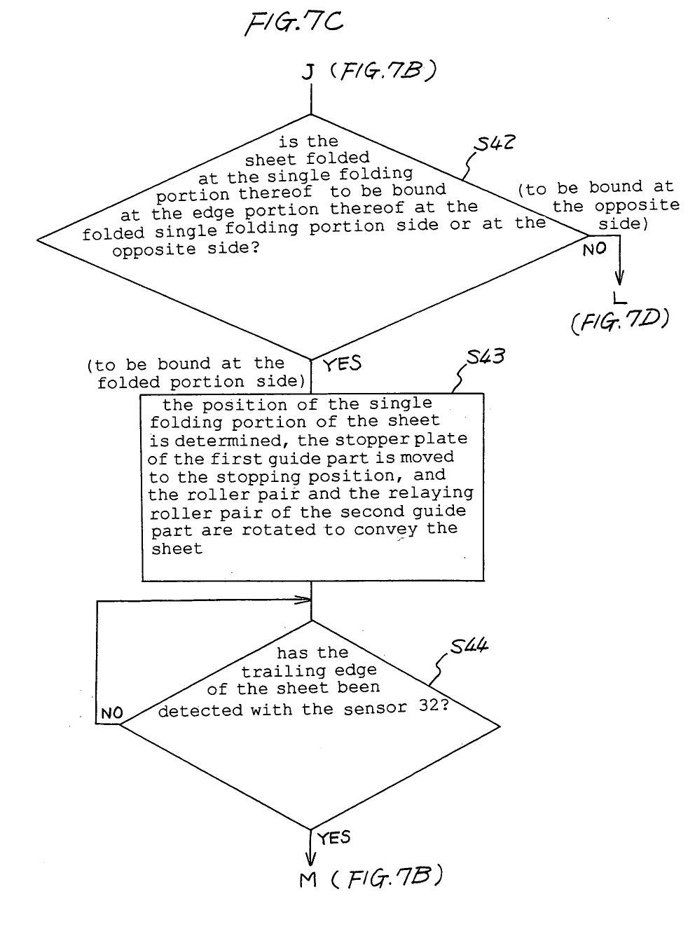

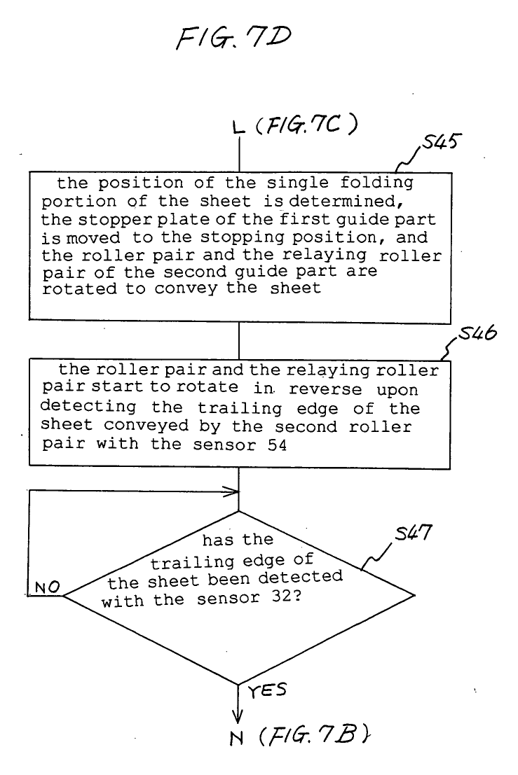

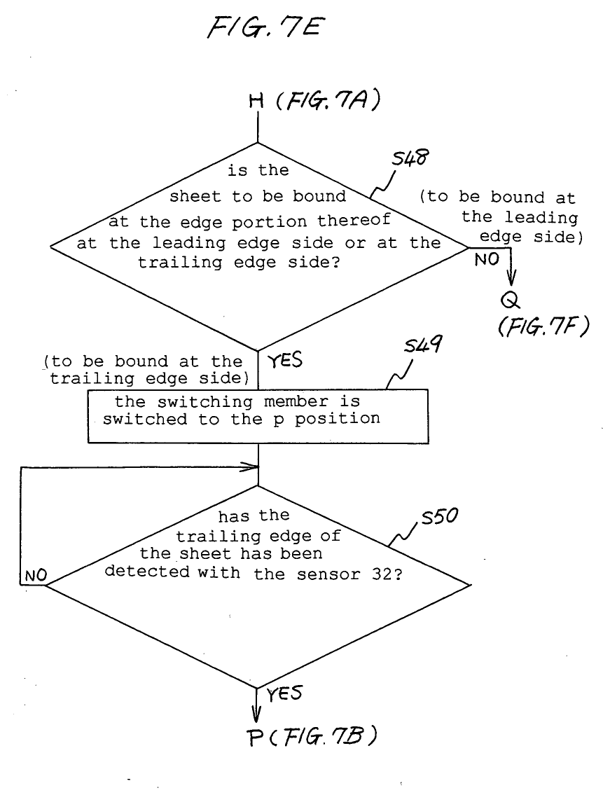

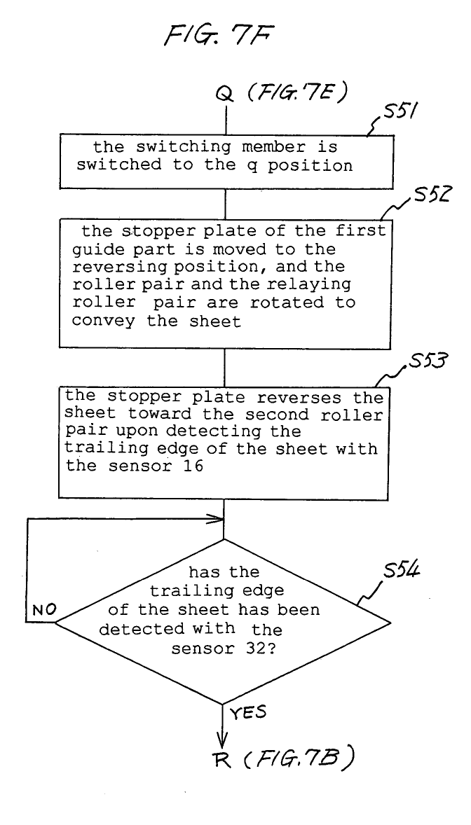

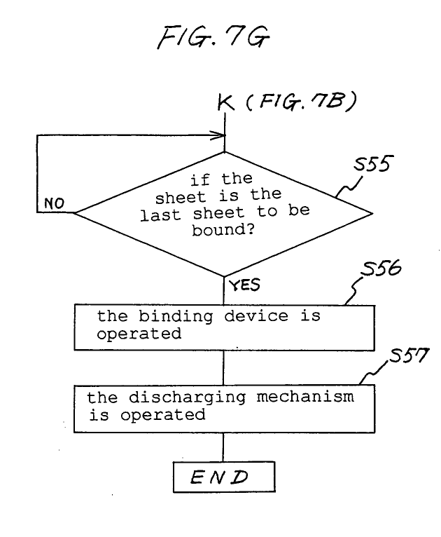

FIG. 7A through FIG. 7G illustrates a flowchart of an exemplary operation of the binding apparatus 2 of FIG. 6.

When the binding apparatus 2 is turned on, the entry roller pair 6 of the entry part 4, the conveying roller pair 9 and the registration roller pair 11 of the first path 8, the first roller pair 13, the second roller pair 14 and the third roller pair 15 of the folding part 12, and the discharge roller 31 of the second path 30 start to rotate. The switching member 7 of the entry part 4 is moved to the p position in which the sheet 3 conveyed by the entry roller pair 6 is conveyed to the second path 30, the tray 34 of the receiving/jogging part 33 is moved to the upper position (indicated by a solid line in FIG. 6), and the end plate 37 and the side guide plate 38 of the receiving/jogging part 33 are moved to respective start positions (the most outside positions).

When the sheet 3 discharged from the image forming apparatus 1 and put into the opening of the entry part 4 of the binding apparatus 2 is detected with the entry sensor 5 (Yes in step S31), whether the sheet 3 is to be folded and bound or is to be bound, without being folded, is determined according to the instruction received from the image forming apparatus 1 (step S32). When it has been determined in step S32 that the sheet 3 is to be folded and bound, the switching member 7 is switched to the q position (step S33), so that the sheet 3 is conveyed to the first path 8.

The sheet 3 conveyed to the first path 8 is conveyed by the conveying roller pair 9, and when the leading edge of the sheet 3 has been detected by the sensor 10 (Yes in step S34), after a predetermined time, the registration roller pair 11 is stopped to be rotated and after a predetermined time, is rotated again (step S35). Thereby, a deviation in the conveying direction of the sheet 3, such as skewing, is corrected.

Thereafter, the sheet 3 is conveyed with the first roller pair 13 to the first guide part 18. When the leading edge of the sheet 3 has been detected with the sensor 16 (Yes in step S36), whether the sheet 3 is to be folded at a single folding portion (in two-folding) or at two folding portions thereof (in Z-folding) is determined according to the instruction received from the image forming apparatus 1 (step S37).

When it has been determined in step S37 that the sheet 3 is to be folded at two folding portions thereof (in Z-folding), the positions of the two folding portions of the sheet 3 are determined according to the instruction received from the image forming apparatus 1, and the stopper plate 20 of the first guide part 18 is moved to the position separate from the nip of the first roller pair 13 by the distance corresponding to the length of the sheet 3 from the leading edge to the first folding portion of the two folding portions of the sheet 3, and the roller pair 23 of the second guide part 21 is rotated in the arrow direction in FIG. 6 (step S38). Thereby, the sheet 3 being conveyed by the first roller pair 13 is stopped in the timing that the sheet 3 has been conveyed by the first roller pair 13 the distance corresponding to the length of the sheet 3 from the leading edge to the first folding portion of the two folding portions of the sheet 3, so that the sheet 3 is folded by the second roller pair 14 at the first folding portion thereof, and the sheet 3 is conveyed to the second guide part 21. The roller pair 23 is stopped to be rotated in the timing that the sheet 3 has been conveyed by the second roller pair 14 the distance corresponding to the length of the sheet 3 from the first folding portion to the second folding portion of the sheet 3 (step S39), so that the sheet 3 being conveyed by the second roller pair 14 is stopped in the timing that the sheet 3 has been conveyed by the second roller pair 14 by the distance corresponding to the length of the sheet 3 from the first folding portion to the second folding portion of the sheet 3, the sheet 3 is thereby folded by the third roller pair 15 at the second folding portion thereof and is conveyed by the third roller pair 15 to the discharge path 50.

When the trailing edge of the sheet 3 has been detected with the sensor 32 (Yes in step S40), the sheet jogging mechanism (the end plate 37, etc.) of the receiving/jogging part 33 is operated (step S41).

When it has been determined in step S37 that the sheet 3 is to be folded at a single folding portion thereof (in two-folding), whether the sheet 3 folded at the single folding portion thereof is to be bound at the edge portion thereof at the folded single folding portion side or at the edge portion thereof opposite the folded single folding portion is determined (step S42). When it has been determined in step S42 that the sheet 3 folded at the single folding portion thereof is to be bound at the edge portion thereof opposite the folded single folding portion, the position of the single folding portion of the sheet 3 is determined according to the instruction received from the image forming apparatus 1, the stopper plate 20 of the first guide part 18 is moved to the position separate from the nip of the first roller pair 13 by the distance corresponding to the length of the sheet 3 from the leading edge to the single folding portion of the sheet 3, and the roller pair 23 arranged in the second guide part 21 and the relaying roller pair 53 arranged at the end of the second guide part 21 are rotated in the arrow directions in FIG. 6 (step S43). Thereby, the sheet 3 being conveyed by the first roller pair 13 is stopped by the stopper plate 20 in the timing that the sheet 3 has been conveyed by the first roller pair 13 by the distance corresponding to the length of the sheet 3 from the leading edge to the single folding portion of the sheet 3, so that the sheet 3 is fold by the second roller pair 14 at the single folding portion thereof and is conveyed by the second roller pair 14 to the second guide part 21, and thereafter, the sheet 3 is conveyed further by the roller pair 23 and the relaying roller pair 53 rotating in the arrow directions in FIG. 6, respectively, and is guided by the second guide part 21 to be discharged onto the downstream side portion of the second path 30, and the sheet 3 is then discharged onto the tray 34 of the receiving/jogging part 33. When the trailing edge of the sheet 3 has been detected with the sensor 32 (Yes in step S44), the jogging mechanism of the receiving/jogging part 33 is operated (step S41).

When it has been determined in step S42 that the sheet 3 folded at the single folding portion thereof is to be bound at the edge portion thereof at the folded single folding portion side, the position of the single folding portion of the sheet 3 is determined according to the instruction received from the image forming apparatus 1, the stopper plate 20 of the first guide part 18 is moved to the position separate from the nip of the first roller pair 13 by the distance corresponding to the length of the sheet 3 from the leading edge to the single folding portion of the sheet 3, and the roller pair 23 arranged in the second guide part 21 and the relaying roller pair 53 arranged at the end of the second guide part 21 are rotated in the arrow directions in FIG. 6 (step S45). Thereby, the sheet 3 being conveyed by the first roller pair 13 is stopped by the stopper plate 20 in the timing that the sheet 3 has been conveyed by the first roller pair 13 by the distance corresponding to the length of the sheet 3 from the leading edge to the single folding portion of the sheet 3, so that the sheet 3 is fold by the second roller pair 14 at the single folding portion thereof and is conveyed by the second roller pair 14 to the second guide part 21, and the sheet 3 is further conveyed by the roller pair 23 and the relaying roller pair 53 of the second guide part 21. The roller pair 23 and the relaying roller pair 53 start to rotate in reverse upon detecting the trailing edge of the sheet 3 conveyed by the second roller pair 14 with the sensor 54 (step S46), so that the sheet 3 is reversed to the third roller pair 15 and is conveyed by the third roller pair 15 to the discharge path 50, and thereafter, the sheet 3 is discharged onto the end portion of the second path 30 and is then discharged onto the tray 34 of the receiving/jogging part 33. When the trailing edge of the sheet 3 has been detected with the sensor 32 (Yes in step S47), the jogging mechanism of the receiving/jogging part 33 is operated (step S41).

When it has been determined in step S32 that the sheet 3 is to be bound, without being folded, whether the sheet 3 is to be bound at the edge portion thereof at the leading edge side or at the trailing edge side is determined (step S48). When it has been determined in step S48 that the sheet 3 is to be bound at the edge portion at the trailing edge side, the switching member 7 is switched to the p position (step S49), so that the sheet 3 is conveyed to the second path 30. The sheet 3 is conveyed with the discharge roller pair 31 and is discharged onto the tray 34 of the receiving/jogging part 33 as an unfolded sheet. When the trailing edge of the sheet 3 has been detected with the sensor 32 (Yes in step S50), the jogging mechanism of the receiving/jogging 33 is operated (step S41).

When it has been determined in step S48 that the sheet 3 is to be bound at the edge portion thereof at the trailing edge side, the switching member 7 is switched to the q position (step S51), so that the sheet 3 is conveyed to the second path 30. The stopper plate 20 is moved to a reversing position corresponding to the length of the sheet 3 in the direction in which the sheet 3 is conveyed by the entry part 4 and the roller pair 23 and the relaying roller pair 53 start to rotate in the arrow directions in FIG. 6 (step S52). When the trailing edge of the sheet 3 conveyed by the first roller pair 13 has been detected with the sensor 16, the stopper plate 20 pushes back the sheet 3 toward the second roller pair 14 (step S53), so that the sheet 3 is conveyed by the second roller pair 14 to the second guide part 21 as an unfolded sheet, and the sheet 3 is conveyed by the roller pair 23 and the relaying roller pair 53 to be discharged onto the downstream side portion of the second path 30, and thereafter, the sheet 3 is discharged onto the tray 34 of the receiving/jogging part 33. When the trailing edge of the sheet 3 has been detected with the sensor 32 (Yes in step S54), the jogging mechanism of the receiving/jogging 33 is operated (step S41).

The sheet 3 discharged onto the tray 34 of the receiving/jogging part 33 from the discharge path 50, the second guide part 21, or the second path 30 is aligned with the stopping plate 39 by the reciprocating movement of the end plate 37 of the receiving/jogging part 33 against the stopping plate 39 and with the side plate of the receiving/jogging part 33 at the rear side of the tray 34 in the widthwise direction of the tray 34 by the reciprocating movement of the side guide plate 38 against the side plate.

Thereafter, it is determined if the sheet 3 is the last sheet to be bound or if a predetermined number of the sheet 3 has been discharged onto the tray 34 of the receiving/jogging part 33 according to the instruction received from the image forming apparatus 1 (step S55). When it has been determined that the sheet 3 is the last sheet to be bound or the predetermined number of the sheet 3 has been discharged onto the tray 34 of the receiving/jogging part 33 (Yes in step S55), the end plate 37 is move to the jogging position at the side of the binding part 44 and the side guide plate 38 is moved to the jogging position at the side of the side plate, and the binding device of the binding part 44 is operated to bind the stack of the sheet 3 on the tray 34 of the receiving/jogging part 33 (step S56).

Then, the discharging mechanism (the arm mechanism of the discharge part 41, etc.) of the discharge part 41 is operated to discharge the bound stack of the sheet 3 on the tray 34 to the discharge tray (step S57). Specifically, the arm mechanism of the discharge part 41 moves the stopping plate 39 of the binding part 44 and the end plate 37 of the receiving/jogging part 33 toward the end side of the tray 34 opposite the end side thereof where the binding part 44 is arranged, so that the stack of the sheet 3 on the tray 34 is moved toward the end side of the tray 34 opposite the end side thereof where the binding part 44 is arranged a predetermined distance. Thereafter, when the sensor 40 has detected the existence of the stack of the sheet 3 on the tray 34, the tray 34 is lowered to the position indicated by the two-dot-dashed line in FIG. 6, and the end plate 37 moves to push the stack of the sheet 3 on the tray 34 to the discharge part 41. Further, when the stack of the sheet 3 has been detected with the sensor 42, the discharge roller pair 43 starts to rotate, so that the stack of the sheet 3 is discharged to the discharge tray.

Numerous additional modifications and variations of the present invention are possible in light of the above-teachings. It is therefore to be understood that within the scope of the claims, the present invention can be practiced otherwise than as specifically described herein.

What is claimed is:

1. A sheet folding and binding apparatus connected with an image forming apparatus and operated based on an instruction from the image forming apparatus, the sheet folding and binding apparatus comprising:
a receiving device configured to receive a sheet discharged from the image forming apparatus and to convey the sheet further;
a folding device configured to fold the sheet conveyed by the receiving device according to the instruction from the image forming apparatus either at a single folding portion thereof or at two folding portions thereof and to convey the sheet further, the folding device including a first folding part configured to fold the sheet conveyed by the receiving device, when folding the sheet at a single folding portion thereof, at the single folding portion thereof, and when folding the sheet at two folding portions thereof, at a first folding portion of the two folding portions thereof, and to convey the sheet folded at the single folding portion thereof with the folded single folding portion thereof placed as a leading edge of the sheet and the sheet folded at the first folding portion of the two folding portions thereof with the folded first folding portion thereof placed as a leading edge of the sheet, and a second folding part configured to convey the sheet folded at the single folding portion thereof and conveyed with the folded single folding portion thereof placed as the leading edge of the sheet by the first folding part further, without folding the sheet, and to fold the sheet folded at the first folding portion of the two folding portions thereof and conveyed with the folded first folding portion thereof placed as the leading edge of the sheet by the first folding part, at a second folding portion of the two folding portions thereof and to convey the sheet folded at the first folding portion and the second folding portion thereof with the folded second folding portion thereof placed as a leading edge of the sheet;
a receiving/jogging device including a tray and configured to receive the sheet conveyed by the folding device one after another on the tray and to jog the sheet one after another so as to be stacked into a stack of the sheet on the tray;
a binding device arranged at one end side of the tray of the receiving/jogging device and configured to bind the stack of the sheet on the tray of the receiving/jogging device; and
a discharge device configured to discharge the stack of the sheet on the tray of the receiving/jogging device, that has been bound by the binding device,
wherein the sheet folded at the single folding portion thereof is bound by the binding device at an edge portion thereof at the folded single folding portion side and the sheet folded at the first folding portion and the second folding portion thereof is bound by the binding device at an edge portion thereof opposite the folded second folding portion thereof.

2. The sheet folding and binding apparatus according to claim 1, wherein the second folding part of the folding device is configured to discharge the sheet folded at the single folding portion thereof and conveyed with the folded single folding portion thereof placed as the leading edge of the sheet by the first folding part, without folding the sheet, directly onto the tray of the receiving/jogging device from an end side of the tray opposite the one end side thereof where the binding device is arranged, so that the sheet folded at the single folding portion thereof is received by the receiving/jogging device on the tray thereof with the folded single folding portion thereof located at the one end side of the tray where the binding device is arranged and thereby the sheet folded at the single folding portion thereof is bound by the binding device at the edge portion thereof at the folded single folding portion side.

3. The sheet folding and binding apparatus according to claim 1, further comprising a reversing device arranged downstream of the second folding part of the folding device in a direction in which the sheet folded at the first folding portion and the second folding portion thereof is conveyed by the second folding part with the folded second folding portion thereof placed as the leading edge of the sheet and configured to reverse the sheet conveyed by the second folding part and to discharge the sheet directly onto the tray of the receiving/jogging device from an end side of the tray opposite the one end side thereof where the binding device is arranged, so that the sheet folded at the first folding portion and the second folding portion thereof is received by the receiving/jogging device on the tray thereof with an end of the sheet opposite the folded second folding portion thereof located at the one end side of the tray where the binding device is arranged and thereby the sheet folded at the first folding portion and the second folding portion thereof is bound by the binding device at the edge portion thereof opposite the folded second folding portion thereof.

4. The sheet folding and binding apparatus according to claim 1, further comprising a discharge path arranged downstream of the second folding part of the folding device in a direction in which the sheet folded at the first folding portion and the second folding portion thereof is conveyed by the second folding part with the folded second folding portion thereof placed as the leading edge of the sheet and configured to discharge the sheet folded at the first folding portion and the second folding portion thereof and conveyed by the second folding part with the folded second folding portion thereof placed as the leading edge of the sheet onto the tray of the receiving/jogging device from the one end side of the tray where the binding device is arranged, so that the sheet folded at the first folding portion and the second folding portion thereof is received by the receiving/jogging device on the tray thereof with an end of the sheet opposite the folded second folding portion thereof located at the one end side of the tray where the binding device is arranged and thereby the sheet folded at the first folding portion and the second folding portion thereof is bound by the binding device at the edge portion thereof opposite the folded second folding portion thereof.

5. The sheet folding and binding apparatus according to claim 1, further comprising a first conveying path configured to convey the sheet conveyed by the receiving device to the folding device, a second conveying path configured to convey the sheet conveyed by the receiving device, without passing the folding device, directly onto the tray of the receiving/jogging device as an unfolded sheet from the one end side of the tray where the binding device is arranged, and a switching device configured to switch a conveying direction of the sheet conveyed by the receiving device according to the instruction from the image forming apparatus, when folding the sheet at a single folding portion or at two folding portions thereof, to the first conveying path, and when conveying the sheet, without folding the sheet, directly onto the tray of the receiving/jogging device as an unfolded sheet, to the second conveying path, so that the sheet as an unfolded sheet and the sheet folded at a single folding portion or at two folding portions thereof may be mixed in the stack of the sheet on the tray.

6. The sheet folding and binding apparatus according to claim 1, further comprising a sheet conveying direction correction device arranged between the receiving device and the first folding part of the folding device and configured to correct a deviation in a conveying direction of the sheet conveyed by the receiving device so that the sheet is folded by the first folding part of the folding device in such a manner that, when the sheet is folded at the single folding portion thereof, the folded single folding portion thereof, and when the sheet is folded at the first folding portion of the two folding portions thereof, the folded first folding portion thereof is perpendicular to side edges of the sheet.

7. The sheet folding and binding apparatus according to claim 1, wherein the first folding part of the folding device is configured to fold the sheet conveyed by the receiving device, when folding the sheet at two folding portions thereof, such that the first folding portion of the two folding portions thereof is a portion of the sheet one-fourth of a length of the sheet from a leading edge of the sheet in a direction in which the sheet is conveyed by the receiving device, and when folding the sheet at a single folding portion thereof, such that the single folding portion thereof is a center portion of the sheet in the direction in which the sheet is conveyed by the receiving device, and the second folding part of the folding device is configured to fold the sheet folded at the first folding portion of the two folding portions thereof and conveyed by the first folding part with the folded first folding portion thereof placed as the leading edge of the sheet such that the second folding portion of the two folding portions thereof is a portion of the sheet one-fourth of the length of the sheet from the first folding portion thereof.

8. The sheet folding and binding device according to claim 1, wherein the folding device is configured to fold the sheet conveyed by the receiving device, when folding the sheet at two folding portions thereof, to be like a letter Z in a cross section of the sheet after having been folded at the first folding portion and the second folding portion thereof.

9. The sheet folding and binding apparatus according to claim 1, wherein the first folding part of the folding device is configured to reverse the sheet conveyed by the receiving device, without folding the sheet, to the second folding part of the folding device as an unfolded sheet, according to the instruction from the image forming apparatus, and the second folding part is configured to convey the sheet reversed from the first folding part further, without folding the sheet, according to the instruction from the image forming apparatus, and to discharge the sheet onto the tray of the receiving/jogging device as an unfolded sheet from the one end side of the tray where the binding device is arranged, so that the sheet conveyed by the receiving device is received by the receiving/jogging device on the tray thereof with a leading edge of the sheet when the sheet has been conveyed by the receiving device located at the one end side of the tray where the binding device is arranged.

10. The sheet folding and binding apparatus according to claim 1, further comprising a discharge path arranged downstream of the second folding part of the folding device in a direction in which the sheet folded at the first folding portion and the second folding portion thereof is conveyed by the second folding part with the folded second folding portion thereof placed as the leading edge of the sheet and configured to discharge the sheet conveyed by the second folding part onto the tray of the receiving/jogging device from the one end side of the tray where the binding device is arranged,
wherein the second folding part of the folding device is configured to reverse the sheet folded at the single folding portion thereof and conveyed with the folded single folding portion thereof placed as the leading edge of the sheet by the first folding part to the discharge path, according to the instruction from the image forming apparatus, so that the sheet folded at the single folding portion thereof is discharged by the discharge path onto the tray of the receiving/jogging device and is received by the receiving/jogging device on the tray thereof with the folded single folding portion thereof located at the one end side of the tray where the binding device is arranged and thereby the sheet folded at the single folding portion thereof is bound by the binding device at the edge portion thereof at the folded single folding portion side.

11. The sheet folding and binding apparatus according to claim 1, wherein the first folding part of the folding device includes a first roller pair configured to convey the sheet conveyed by the receiving device, a first guide device configured to guide the sheet being conveyed by the first roller pair, the first guide device including a stopping device configured to stop the sheet being conveyed by the first roller pair and guided by the first guide device according to the instruction from the image forming apparatus, when folding the sheet at two folding portions thereof, in a timing that the sheet has been conveyed by the first roller pair a distance corresponding to a length of the sheet from a leading edge to the first folding portion of the two folding portions thereof, and when folding the sheet at a single folding portion thereof, in a timing that the sheet has been conveyed by the first roller pair a distance corresponding to a length of the sheet from the leading edge to the single folding portion thereof, and a second roller pair configured to fold the sheet being conveyed by the first roller pair and stopped by the stopping device of the first guide device in the timing that the sheet has been conveyed by the first roller pair the distance corresponding to the length of the sheet from the leading edge to the first folding portion of the two folding portions thereof, at the first folding portion thereof, and to convey the sheet with the folded first folding portion thereof placed as the leading edge of the sheet, and the sheet being conveyed by the first roller pair and stopped by the stopping device of the first guide device in the timing that the sheet has been conveyed by the first roller pair the distance corresponding to the length of the sheet from the leading edge to the single folding portion thereof, at the single folding portion thereof, and to convey the sheet with the folded single folding portion thereof placed as the leading edge of the sheet, and the second folding part of the folding device includes a second guide device configured to guide the sheet folded at the first folding portion of the two folding portions thereof and conveyed with the folded first folding portion thereof placed as the leading edge of the sheet by the second roller pair and the sheet folded at the single folding portion thereof and conveyed with the folded single folding portion thereof placed as the leasing edge of the sheet by the second roller pair, the second guide device including a stopping/conveying device configured to convey the sheet folded at the single folding portion thereof and conveyed with the folded single folding portion thereof placed as the leading edge of the sheet by the second roller pair further, without stopping the sheet, and to stop the sheet, folded at the first folding portion of the two folding portions thereof and conveyed with the folded first folding portion thereof placed as the leading edge of the sheet by the second roller pair, in a timing that the sheet has been conveyed by the second roller pair a distance corresponding to a length of the sheet from the first folding portion to the second folding portion thereof, according to the instruction from the image forming apparatus, and a third roller pair configured to fold the sheet folded at the first folding portion thereof and being conveyed with the folded first folding portion thereof placed as the leading edge of the sheet by the second roller pair and stopped by the stopping/conveying device of the second guide device in the timing that that sheet has been conveyed by the second roller pair the distance corresponding to the length of the sheet from the first folding portion to the second folding portion thereof, at the second folding portion thereof, and to convey the sheet folded at the first folding portion and the second folding portion thereof with the folded second folding portion thereof placed as the leading edge of the sheet.

12. The sheet folding and binding apparatus according to claim 11, wherein the second guide device of the second folding part of the folding device is configured to guide the sheet folded at the single folding portion thereof and conveyed with the folded single folding portion thereof placed as the leading edge of the sheet by the second roller pair and conveyed by the stopping/conveying device, without being stopped, to be discharged directly onto the tray of the receiving/jogging device from an end side of the tray opposite the one end side thereof where the binding device is arranged, so that the sheet folded at the single folding portion thereof is received by the receiving/jogging device on the tray thereof with the folded single folding portion thereof located at the one end side of the tray where the binding device is arranged and thereby the sheet folded at the single folding portion thereof is bound by the binding device at the edge portion thereof at the folded single folding portion side.

13. The sheet folding and binding apparatus according to claim 11, wherein the stopping device of the first guide device of the first folding part of the folding device is configured to reverse the sheet conveyed by the first roller pair and guided by the first guide device to the second roller pair so that the sheet is conveyed by the second roller pair as an unfolded sheet, according to the instruction from the image forming apparatus, the second guide device of the second folding part of the folding device is configured to guide the sheet conveyed by the second roller pair as an unfolded sheet to be discharged onto the tray of the receiving/jogging device from the one end side of the tray where the binding device is arranged, and the stopping/conveying device of the second guide device of the second folding part is configured to convey the sheet conveyed by the second roller pair as an unfolded sheet and guided by the second guide device further, without stopping the sheet, according to the instruction from the image forming apparatus, so that the sheet conveyed by the receiving device is received by the receiving/jogging device on the tray thereof as an unfolded sheet with a leading edge of the sheet when the sheet has been conveyed by the receiving device located at the one end side of the tray where the binding device is arranged.

14. The sheet folding and binding apparatus according to claim 11, further comprising a discharge path arranged downstream of the third roller pair of the second folding part of the folding device in a direction in which the sheet folded at the first folding portion and the second folding portion thereof is conveyed by the third roller pair with the folded second folding portion thereof placed as the leading edge of the sheet and configured to convey the sheet conveyed by the third roller pair to be discharged onto the tray of the receiving/jogging device from the one end side of the tray where the binding device is arranged,
wherein the stopping/conveying device of the second guide device of the second folding part of the folding device is configured to reverse the sheet, folded at the single folding portion thereof and conveyed with the folded single folding portion thereof placed as the leading edge of the sheet by the second roller pair of the first folding part, to the third roller pair, according to the instruction from the image forming apparatus, so that the sheet folded at the single folding portion thereof is discharged by the discharge path onto the tray of the receiving/jogging device and is received by the receiving/jogging device on the tray thereof with the folded single folding portion thereof located at the one end side of the tray where the binding device is arranged and thereby the sheet folded at the single folding portion thereof is bound by the binding device at the edge portion thereof at the folded single folding portion side.

15. The sheet folding and binding apparatus according to claim 11, wherein the stopping device of the first guide device includes a stopper plate configured to be moved according to the instruction from the image forming apparatus, when folding the sheet being conveyed by the first roller pair and guided by the first guide device at two folding portions thereof, to a stopping position separate from a nip of the first roller pair by a distance corresponding to the length of the sheet from the leading edge to the first folding portion of the two folding portions thereof to regulate a leading edge of the sheet being conveyed by the first roller pair and guided by the first guide device and to thereby stop the sheet in the timing that the sheet has been conveyed by the first roller pair the distance corresponding to the length of the sheet from the leading edge to the first folding portion of the two folding portions thereof so that the sheet is folded by the second roller pair at the first folding portion thereof, and when folding the sheet being conveyed by the first roller pair and guided by the first guide device at a single folding portion thereof, to a stopping position separate from the nip of the first roller pair by a distance corresponding to the length of the sheet from the leading edge to the single folding portion thereof to regulate the leading edge of the sheet being conveyed by the first roller pair and guided by the first guide device and to thereby stop the sheet in the timing that the sheet has been conveyed by the first roller pair the distance corresponding to the length of the sheet from the leading edge to the single folding portion thereof so that the sheet is folded by the second roller pair at the single folding portion thereof.

16. The sheet folding and binding apparatus according to claim 15, wherein the stopper plate of the stopping device of the first guide device of the first folding part of the folding device is configured to be moved to a reversing position separate from the nip of the first roller pair by a distance corresponding to the length of the sheet conveyed by the receiving device to regulate the leading edge of the sheet being conveyed by the first roller pair and guided by the first guide device and to reverse the sheet to the second roller pair so that the sheet is conveyed by the second roller pair as an unfolded sheet, according to the instruction from the image forming apparatus, and the second guide device of the second folding part is configured to guide the sheet being conveyed by the second roller pair as an unfolded sheet to be discharged onto the tray of the receiving/jogging device from the one end side of the tray where the binding device is arranged, and the stopping/conveying device of the second guide device is configured to convey the sheet conveyed by the second roller pair as an unfolded sheet and guided by the second guide device, without stopping the sheet, according to the instruction from the image forming apparatus, so that the sheet conveyed by the receiving device is received by the receiving/jogging device on the tray thereof as an unfolded sheet with a leading edge of the sheet when the sheet has been conveyed by the receiving device located at the one end side of the tray where the binding device is arranged.

17. The sheet folding and binding apparatus according to claim 11, wherein the stopping device of the first guide device includes a roller pair arranged in a fixed position and configured to be rotated to convey the sheet being conveyed by the first roller pair and guided by the first guide device and to be rotated in reverse according to the instruction from the image forming apparatus, when folding the sheet being conveyed by the first roller pair and guided by the first guide device at two folding portions thereof, in the timing that the sheet has been conveyed by the first roller pair the distance corresponding to the length of the sheet from the leading edge to the first folding portion of the two folding portions thereof so that the sheet is folded by the second roller pair at the first folding portion thereof, and when folding the sheet being conveying by the first roller pair and guided by the first guide device at a single folding portion thereof, in the timing that the sheet has been conveyed by the first roller pair the distance corresponding to the length of the sheet from the leading edge to the single folding portion thereof so that the sheet is folded by the second roller pair at the single folding portion thereof.

18. The sheet folding and binding apparatus according to claim 17, wherein the roller pair of the stopping device of the first guide device is configured to be rotated to convey the sheet being conveyed by the first roller pair and guided by the first guide device and to be rotated in reverse in the timing that the sheet has been conveyed by the first roller pair the distance corresponding to the length of the sheet to reverse the sheet conveyed by the first roller pair and guided by the first guide device to the second roller pair so that the sheet is conveyed by the second roller pair as an unfolded sheet, according to the instruction from the image forming apparatus, the second guide device is configured to guide the sheet conveyed by the second roller pair to be discharged onto the tray of the receiving/jogging device from the one end side of the tray where the binding device is arranged, and the stopping/conveying device of the second guide device of the second folding part of the folding device is configured to convey the sheet conveyed by the second roller pair as an unfolded sheet and guided by the second guide device, without stopping the sheet, according to the instruction from the image forming apparatus, so that the sheet conveyed by the receiving device is received by the receiving/jogging device on the tray thereof as an unfolded sheet with a leading edge of the sheet when the sheet has been conveyed by the receiving device located at the one end side of the tray where the binding device is arranged.

19. The sheet folding and binding apparatus according to claim 11, wherein the stopping/conveying device of the second guide device includes a roller pair configured to be moved according to the instruction from the image forming apparatus, when folding the sheet being conveyed by the first roller pair and guided by the first guide device at two folding portions thereof, to a stopping position separate from a nip of the second roller pair by a distance corresponding to a length of the sheet from the first folding portion to the second folding portion thereof and to be stopped to be rotated to regulate a leading edge of the sheet folded at the first folding portion of the two folding portions thereof and being conveyed by the second roller pair with the folded first folding portion thereof placed as the leading edge of the sheet and guided by the second guide device so that the sheet folded at the first folding portion thereof and being conveyed by the second roller pair of the first folding part and guided by the second guide device is stopped in the timing that the sheet has been conveyed by the second roller pair the distance corresponding to the length of the sheet from the first folding portion to the second folding portion thereof and thereby the sheet is folded by the third roller pair at the second folding portion thereof, and when folding the sheet being conveyed by the first roller pair and guided by the first guide device at a single folding portion thereof, to a predetermined conveying position and to be rotated to convey the sheet folded at the single folding portion thereof and being conveyed by the second roller pair with the folded single folding portion thereof placed as the leading edge of the sheet and guided by the second guide device further, without stopping the sheet.

20. The sheet folding and binding apparatus according to claim 11, wherein the stopping/conveying device of the second guide device of the second folding part includes a roller pair arranged in a fixed position and configured to be rotated to convey the sheet folded at the first folding portion thereof and conveyed with the folded first folding portion thereof placed as the leading edge of the sheet by the second roller pair and guided by the second guide device and to be rotated in reverse in the timing that the sheet has been conveyed by the second roller pair the distance corresponding to the length of the sheet from the first folding portion to the second folding portion thereof so that the sheet is folded at the second folding portion thereof by the third roller pair, when folding the sheet being conveyed by the first roller pair and guided by the first guide device at two folding portions thereof, and to be rotated to convey the sheet folded at the single folding portion thereof and conveyed with the folded single folding portion thereof placed as the leading edge thereof by the second roller pair and guided by the second guide device further, without stopping the sheet, when folding the sheet conveyed by the receiving device at the single folding portion thereof, according to the instruction from the image forming apparatus.

21. The sheet folding and binding device according to claim 20, further comprising a discharge path arranged downstream of the third roller pair of the second folding part of the folding device in a direction in which the sheet folded at the first folding portion and the second folding portion thereof is conveyed by the third roller pair with the folded second folding portion thereof placed as the leading edge of the sheet and configured to convey the sheet conveyed by the third roller pair to be discharged onto the tray of the receiving/jogging device from the one end side of the tray where the binding device is arranged,
wherein the roller pair of the stopping/conveying device of the second guide device is configured to be rotated to convey the sheet folded at the single folding portion thereof and conveyed with the folded single folding portion thereof placed as the leading edge of the sheet by the second roller pair and guided by the second guide device and to be rotated in reverse in a timing that the sheet has been conveyed by the second roller pair the distance corresponding to a length of the sheet from the folded single folding portion to a trailing edge thereof to reverse the sheet to the third roller pair, according to the instruction from the image forming apparatus, so that the sheet folded at the single folding portion thereof is discharged by the discharge path onto the tray of the receiving/jogging device and is received by the receiving/jogging device on the tray thereof with the folded single folding portion thereof located at the one end side of the tray where the binding device is arranged and thereby the sheet folded at the single folding portion thereof is bound by the binding device at the edge portion thereof at the folded single folding portion side.

22. The sheet folding and binding apparatus according to claim 11, wherein one roller of the first roller pair is configured to serve as one roller of the second roller pair and the other roller of the second roller pair is configured to serve as one roller of the third roller pair.

23. A sheet folding and binding apparatus connected with an image forming apparatus and operated based on an instruction from the image forming apparatus, the sheet folding and binding apparatus comprising:
means for receiving a sheet discharged from the image forming apparatus and for conveying the sheet further;
means for folding the sheet conveyed by the receiving means according to the instruction from the image forming apparatus either at a single folding portion or at two folding portions thereof and for conveying the sheet, the folding means including first folding means for folding the sheet conveyed by the receiving means, when folding the sheet at a single folding portion thereof, at the single folding portion thereof, and when folding the sheet at two folding portions thereof, at a first folding portion of the two folding portions thereof and for conveying the sheet folded at the single folding portion thereof with the folded single folding portion thereof placed as a leading edge of the sheet and the sheet folded at the first folding portion of the two folding portions thereof with the folded first folding portion thereof placed as a leading edge of the sheet, and second folding means for conveying the sheet folded at the single folding portion thereof and conveyed with the folded single folding portion thereof placed as the leading edge of the sheet by the first folding means further, without folding the sheet, and for folding the sheet folded at the first folding portion thereof and conveyed with the folded first folding portion thereof placed as the leading edge of the sheet by the first folding means at a second folding portion of the two folding portions thereof and for conveying the sheet folded at the first folding portion and the second folding portion thereof with the folded second folding portion thereof placed as a leading edge of the sheet;
means for receiving the sheet conveyed by the folding means one after another on a tray thereof and for jogging the sheet one after another so as to be stacked into a stack of the sheet on the tray;
means for binding the stack of the sheet on the tray of the receiving/jogging means, the binding means being arranged at one end side of the tray of the receiving/jogging means; and
means for discharging the stack of sheet on the tray of the receiving/jogging means, that has been bound by the binding means,
wherein the sheet folded at the single folding portion thereof is bound by the binding means at an edge portion thereof at the folded single folding side and the sheet folded at the first folding portion and the second folding portion thereof is bound by the binding means at an edge portion thereof opposite the folded second folding portion thereof.
